(19) United States
(12) Patent Application Publication
(10) Pub. No.: US 2017/0139384 A1
(43) Pub. Date: May 18, 2017

(54) RECOMMENDATION APPARATUS, RECOMMENDATION METHOD AND NON-TRANSITORY COMPUTER READABLE MEDIUM

(71) Applicant: KABUSHIKI KAISHA TOSHIBA, Tokyo (JP)

(72) Inventors: Ryosuke TAKEUCHI, Tokyo (JP); Shuichiro IMAHARA, Kawasaki (JP); Toru YANO, Tokyo (JP)

(73) Assignee: KABUSHIKI KAISHA TOSHIBA, Tokyo (JP)

(21) Appl. No.: 15/420,680

(22) Filed: Jan. 31, 2017

Related U.S. Application Data
(63) Continuation of application No. PCT/JP2015/057687, filed on Mar. 16, 2015.

(51) Int. Cl. G05B 13/04; G06F 17/30

(52) U.S. Cl. CPC G05B 13/048; G06F 17/3097; G06F 17/30867

(57) ABSTRACT

A recommendation apparatus according to the embodiments of the present invention includes a history acquirer, a matching information calculator, and a recommender. The history acquirer acquires an activity history of a user. The matching information calculator calculates first matching information for the activity history of a pre-condition defined based on an activity of the user, regarding a control rule including the pre-condition and a post-condition indicating content of control performed for a device, the control rule defining to perform the control indicated by the post-condition when the pre-condition is established. The recommender generates recommendation information of the control rule for the user according to the first matching information.

### CROSS-REFERENCE TO RELATED APPLICATION (S)

This application is a Continuation of International Application No. PCT/JP2015/057687, filed on Mar. 16, 2015, the entire contents of which is hereby incorporated by reference.

### FIELD

Embodiments described herein relate generally to a recommendation apparatus, a recommendation method and a non-transitory computer readable medium.

### BACKGROUND

In recent years, a home energy management system (HEMS) is drawing attention. The HEMS is a system for managing energy such as electricity used at home. The HEMS can figure out the status of use of energy at home and can realize energy saving by reducing unnecessary use of energy. The HEMS can also control a device according to a predetermined rule to realize energy saving. For example, if a rule is applied to lower the setting temperature of a heater when nobody is in a room, the HEMS automatically lowers the set temperature when nobody is in the room. Therefore, the energy consumption can be automatically reduced, and energy saving can be realized.

When there is a large number of rules for controlling the device, it is difficult for users to find a rule suitable for themselves. Even if a rule is suitable for the users, the users often do not think that the rule is suitable for the users, and the users do not apply the rule. To handle such a situation, it is desirable that the HEMS recommends a rule suitable for the users. However, even if the rule reflecting the activity of the users is applied, the user may not feel that the rule is helpful.

### BRIEF DESCRIPTION OF THE DRAWINGS

FIG. 1 is a block diagram illustrating a schematic configuration of a recommendation apparatus according to a first embodiment;

FIG. 2 is a diagram illustrating an example of history information stored in an activity history DB;

FIG. 3 is a diagram illustrating an example of history information stored in an environment history DB;

FIG. 4 is a diagram illustrating an example of history information stored in a device operation history DB;

FIG. 5 is a diagram illustrating an example of basic rules stored in a control rule division DB;

FIG. 6 is a diagram illustrating an example of control rule information stored in a control rule DB;

FIGS. 7A and 7B are diagrams illustrating an example of data for calculating a control content satisfaction rate;

FIG. 8 is a diagram illustrating an example of data stored in an index DB;

FIGS. 9A and 9B are conceptual diagrams of creation of a discriminator;

FIG. 10 is a diagram illustrating an example of data stored in a recommendation content DB;

FIG. 11 is a diagram illustrating an example of recommendation sentences output by an output device;

FIG. 12 is a schematic flow chart of a recommendation process in the first embodiment;

FIG. 13 is a flow chart illustrating details of a process of calculating matching rates;

FIG. 14 is a flow chart illustrating details of a process of determining whether to recommend a control rule;

FIG. 15 is a diagram illustrating comparison of a predicted value based on a logistic regression model and a reference value;

FIG. 16 is a block diagram illustrating a schematic configuration of a recommendation apparatus according to a second embodiment;

FIG. 17 is a schematic flow chart of a recommendation process in the second embodiment;

FIG. 18 is a block diagram illustrating a schematic configuration of a recommendation apparatus according to a third embodiment;

FIGS. 19A to 19D are diagrams illustrating an example of data of an alleviation condition stored in a pre-alleviation condition DB;

FIG. 20 is a flow chart illustrating details of a process of calculating the matching rates in the third embodiment;

FIG. 21 is a block diagram illustrating a schematic configuration of a recommendation apparatus according to a fourth embodiment;

FIGS. 22A to 22D are diagrams illustrating an example of data of a post-alleviation condition stored in a post-alleviation condition DB;

FIG. 23 is a block diagram illustrating a schematic configuration of a recommendation apparatus according to a fifth embodiment;

FIG. 24 is a flow chart illustrating details of a process of determining whether to recommend a control rule in the fifth embodiment;

FIG. 25 is a block diagram illustrating a schematic configuration of a recommendation apparatus according to a sixth embodiment;

FIG. 26 is a diagram illustrating an example of recommendation effect calculation methods and the like stored in a recommendation effect DB;

FIGS. 27A and 27B are diagrams illustrating an example of data for calculating a recommendation effect;

FIG. 28 is a diagram illustrating an example of recommendation sentences output by the output device using a result of the recommendation effect;

FIG. 29 is a flow chart illustrating details of a process of determining whether to recommend the control rule in the sixth embodiment;

FIG. 30 is a block diagram illustrating a schematic configuration of a recommendation apparatus according to a seventh embodiment;

FIG. 31 is a diagram illustrating an example of data stored in a recommendation result DB;

FIG. 32 is a schematic flow chart of a recommendation process in the seventh embodiment;

FIG. 33 is a flow chart illustrating details of a process of determining whether to recommend the control rule in the seventh embodiment;

FIG. 34 is a diagram illustrating a case of dividing the components in the first embodiment into a monitoring environment and a service providing environment; and

FIG. 35 is a diagram illustrating an example of hardware configuration including the recommendation apparatus according to an example of the present invention.

### DETAILED DESCRIPTION

In embodiments of the present invention, living activities of each user are taken into account to recommend control rules.

A recommendation apparatus according to the embodiments of the present invention includes a history acquirer, a matching information calculator, and a recommender.

The history acquirer acquires an activity history of a user.

The matching information calculator calculates first matching information for the activity history of a pre-condition defined based on an activity of the user, regarding a control rule including the pre-condition and a post-condition indicating content of control performed for a device, the control rule defining to perform the control indicated by the post-condition when the pre-condition is established.

The recommender generates recommendation information of the control rule for the user according to the first matching information.

Below, a description is given of embodiments of the present invention with reference to the drawings. The present invention is not limited to the embodiments.

### First Embodiment

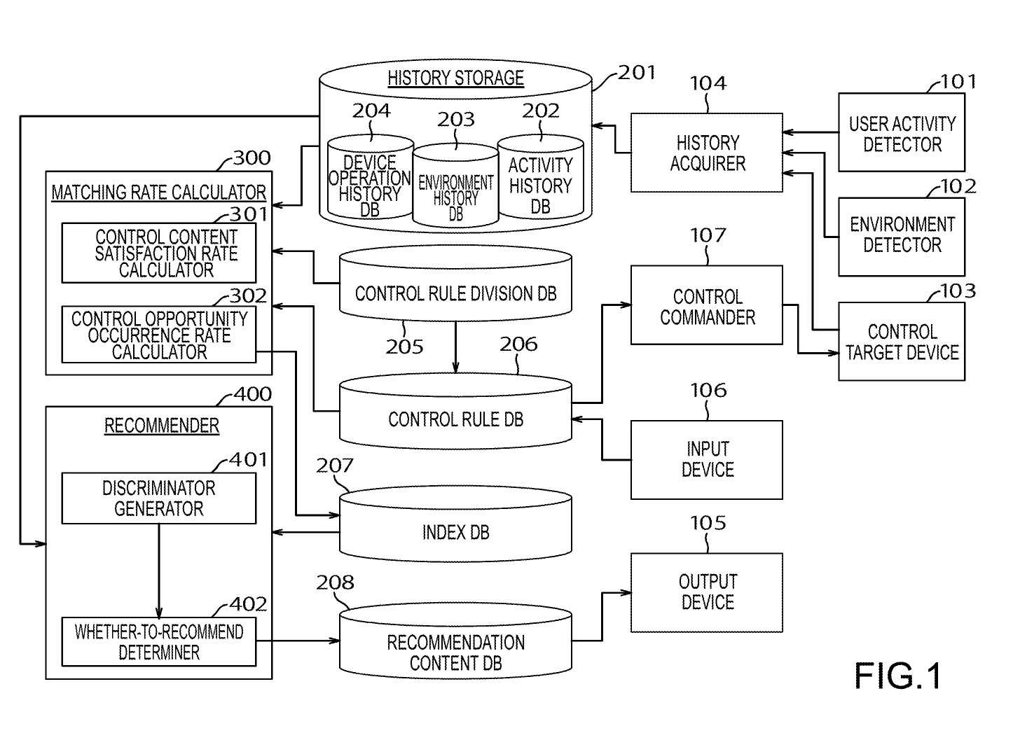

FIG. 1 is a block diagram illustrating a schematic configuration of a recommendation apparatus according to a first embodiment.

The recommendation apparatus of FIG. 1 includes a user activity detector 101, an environment detector 102, a control target device 103, a history acquirer 104, a history storage 201, a control rule division DB 205, a control rule DB 206, an index DB 207, a recommendation content DB 208, a matching rate calculator (matching information calculator) 300, a recommender 400, an output device 105, an input device 106, and a control commander 107. The present recommendation apparatus is arranged on, for example, a structure where the user lives.

The user activity detector 101 detects an activity or a state related to the user. There is a method of using a sensor, such as a human sensor and a sleep sensor. There can also be a method in which an electric device, such as a lighting device, an electric cooker, a mobile phone, a smartphone, and an intercom, sends information to the user activity detector 101 when the electric device is used. The detected information is information related to the activity or the state of the user, such as presence, absence, sleeping, cooking, making a phone call, sending an email, and visiting. The user activity detector 101 also acquires information related to the position of the user when the user activity detector 101 detects an activity of the user. For example, the position can be acquired from the position of the used electronic device or from position information transmitted when a smartphone or the like is used. The obtained information is transmitted to the history acquirer 104. The timing of the transmission of the information may be every certain time, may be every time the information is acquired, or may be arbitrarily defined. The history acquirer 104 may perform polling to acquire the information from the user activity detector 101. A plurality of user activity detectors 101 may also be arranged.

The environment detector 102 detects a state of a living environment of the user or a surrounding environment of the control target device 103. The detected information includes environment information, such as temperature, humidity, illuminance, air flow, precipitation, and snow accumulation. A sensor can be used to detect the information. The obtained information is transmitted to the history acquirer 104. The timing of the transmission of the information may be every certain time, may be every time the information is acquired, or may be arbitrarily defined. The history acquirer 104 may perform polling to acquire the information from the environment detector 102. A plurality of environment detectors 102 may also be arranged.

The control target device 103 is an electric device to be controlled, such as an air conditioner, a lighting device, a smart plug, an electric blind, an electric shutter, and an electric lock. Although it is assumed that the control target device 103 is arranged in the structure where the user lives, part of the device (for example, monitoring apparatus) may be arranged outside of the structure. In the present embodiment, the control target device 103 is controlled by a rule for controlling the electric device (hereinafter, “control rule”). The control target device 103 may hold the control rule, and the control target device 103 may operate according to the control rule. Alternatively, the control commander 107 described later may hold the control rule, and the control commander 107 may issue a command in accordance with the control rule. The control target device 103 may operate according to the command.

The control target device 103 transmits information related to the state of the device, such as ON or OFF of power, set temperature, set illuminance, and open/close state, to the history acquirer 104. The timing of the transmission of the information may be every certain time, may be when the state changes, or may be arbitrarily defined. The history acquirer 104 may perform polling to acquire the information from the control target device 103. Although it is assumed that there are a plurality of control target devices 103, the number of control target devices 103 may be one. It may also be assumed that the power of the control target device 103 is always turned on. In this case, the information related to ON or OFF of power may not be transmitted.

The history acquirer 104 acquires the information detected by the user activity detector 101, the environment detector 102, and the control target device 103 and transmits the information to the history storage 201. One history acquirer 104 may collect the information from all of the user activity detector 101, the environment detector 102, and the control target device 103. Alternatively, a plurality of history acquirers 104 may share the load of collecting the information. When the load of collecting the information is shared, the devices from which the information is collected may be divided into some groups based on the kinds or the positions thereof, and the history acquirers 104 may collect the information only from the associated groups. The timing of the transmission of the information may be every certain time, may be every time the information is acquired, or may be arbitrarily defined.

The history storage 201 includes an activity history DB 202, an environment history DB 203, and a device operation history DB 204. The activity history DB 202, the environment history DB 203, and the device operation history DB 204 may be constructed by using one piece of DB-related software and one storage or by using a plurality of pieces of DB-related software and one or a plurality of storages. Other methods may be used to construct the DBs.

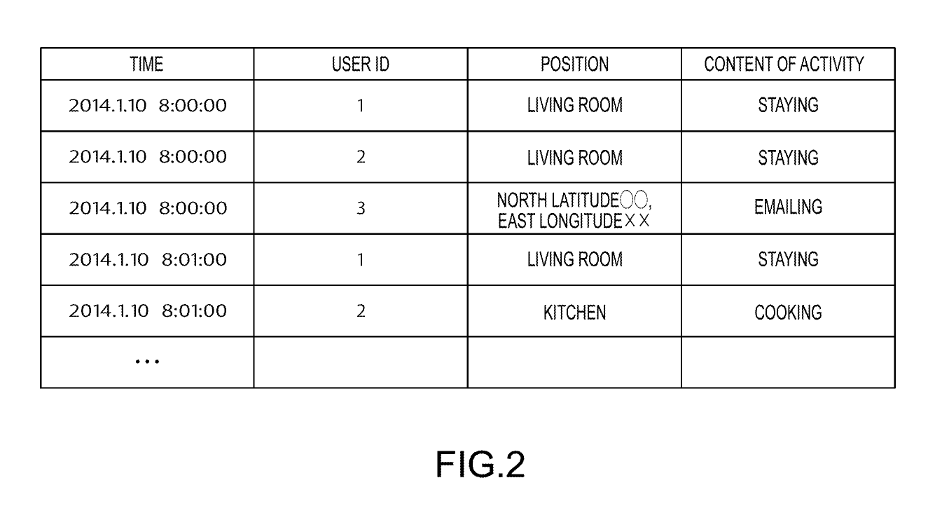

The activity history DB 202 stores the information (activity history information) collected by the user activity detector 101. FIG. 2 is a diagram illustrating an example of the activity history stored in the activity history DB 202. The data in the example of FIG. 2 includes detection time, user IDs, positions of the users, content of activities of the users, and the like. The user ID is an identifier for distinguishing each user and is an ID of the user. The user ID is not limited to the ID for identifying the individual users, but may also be a user ID indicating whole residents in one household or may be a user ID indicating that the user cannot be identified or is unknown.

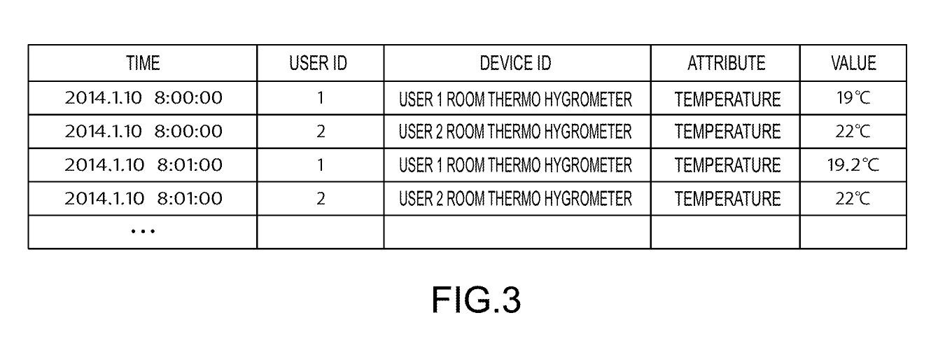

The environment history DB 203 stores the information (environment history information) collected by the environment detector 102. FIG. 3 is a diagram illustrating an example of the environment history information stored in the environment history DB 203. The data in the example of FIG. 3 includes detection time, device IDs, attributes related to the state of the environment, values of the attributes, and the like. The device ID is an identifier for distinguishing the device. The attribute and the value of the attribute indicate the detection item (such as temperature and humidity) of the environment detector 102 and the value of the detection item.

Note that the user ID may be added to the environment history. The user ID of the user that uses the space provided with the device is set in the column of the user ID of FIG. 3. For example, a “user 1 room thermo hygrometer” that is the device ID of the uppermost row in the example of FIG. 3 is arranged in the room of a user “1”, and the user ID is the user “1”. When the device is placed in a living room used by a plurality of users, a plurality of user IDs or a user ID indicating whole residents is set. This can be obtained by preparing a table associating the user ID and the device ID and merging the table with the history information.

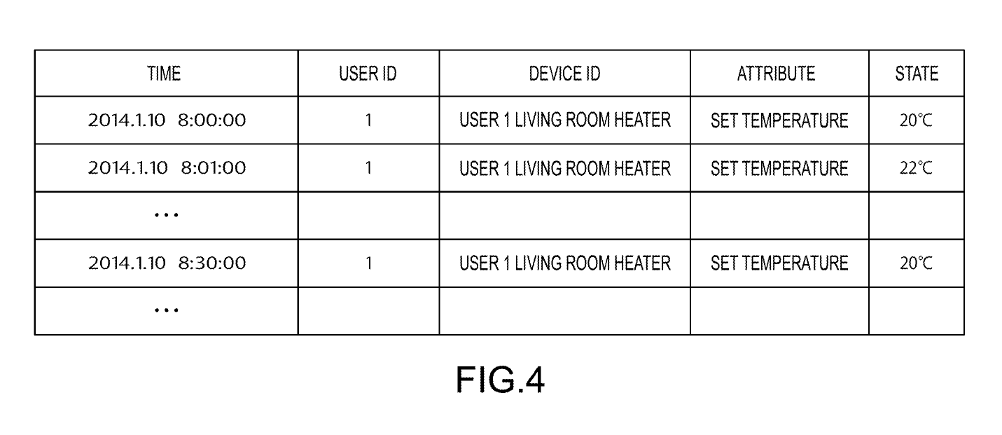

The device operation history DB 204 stores the information (operation history information) collected by the control target device 103. FIG. 4 is a diagram illustrating an example of the operation history information stored in the device operation history DB 204. The data in the example of FIG. 4 includes detection time, device IDs, attributes related to the state of the device, values of the attributes, and the like. The attribute and the value of the attribute respectively indicate the detection item of the operation of the control target device and the value of the detection item. For example, the data of an air conditioner or a heater includes “set temperature” and “20 degrees” that is a value of the “set temperature”.

Note that the user ID may be added to the device operation history. A user ID associated in advance with the device ID, such as an owner of the device or a user that usually uses the device, is set in the column of the user ID of FIG. 4, instead of the user ID of the user that actually uses the device. This can be obtained by preparing a table associating the user ID and the device ID and merging the table with the history information.

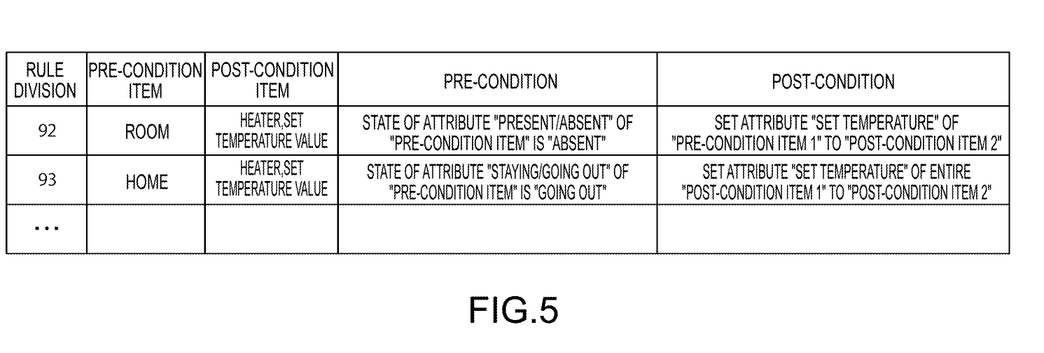

The control rule division DB 205 is a database configured to store a basic rule. The basic rule serves as a template for constructing a control rule. The basic rule is combined with control rule information described later to construct the control rule. FIG. 5 is a diagram illustrating an example of the basic rules. The basic rules in the example of FIG. 5 include rule divisions, pre-condition items, post-condition items, pre-conditions, post-conditions, and the like. The rule division is an identifier for classifying the basic rule. The control rule includes the pre-condition and the post-condition. The control rule is activated when the pre-condition is established, and the content of the post-condition is executed. However, abstract elements (variables) are used to write the “pre-condition” and the “post-condition” of the control rule division DB 205, and values of the elements (variables) are provided to confirm the pre-condition and the post-condition.

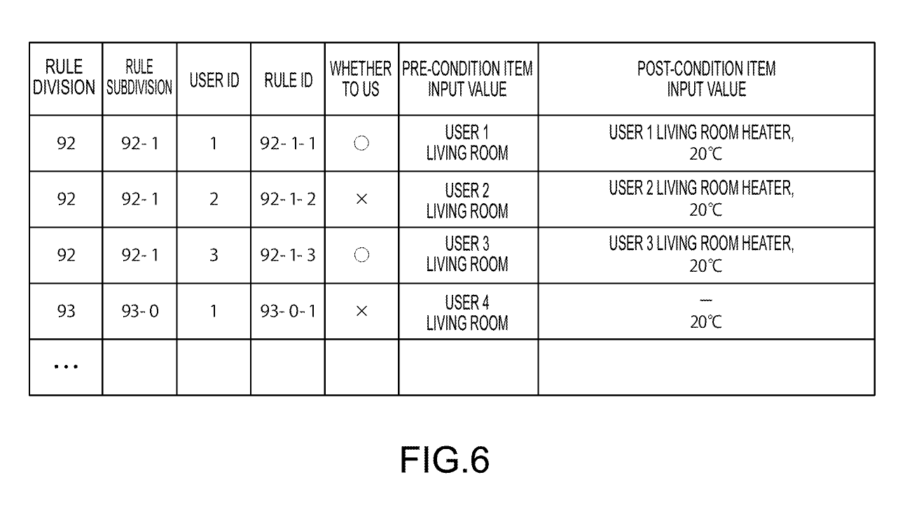

The value provided to the abstract element (variable) in the pre-condition is determined by the “pre-condition item” of FIG. 5 and a “pre-condition item input value” of FIG. 6 described later. The “pre-condition item” indicates a kind or a type (hereinafter, collectively called “type”) of the element, and the “pre-condition item input value” indicates a value provided to the element. In the uppermost row in the example of FIG. 5, the value (type) of the pre-condition item indicates “room”. If the value of the “pre-condition item input value” is “room A”, it is confirmed that the pre-condition denotes that the state of an attribute “present/absent” of the room A is “absent”, i.e. “nobody is in the room A”. Although the number of pre-condition items is one in the example of FIG. 5, there may be a plurality of pre-condition items, and in that case, there are also a plurality of “pre-condition item input values”. In addition, the pre-condition item may not exist. For example, when the pre-condition is described without using an abstract element (e.g. “if thunder rumbles”), the pre-condition item may not exist. In this case, the “pre-condition item input value” may not exist, either.

The value provided to the abstract element in the post-condition is determined by the “post-condition item” and a “post-condition item input value” of FIG. 6 described later. The “post-condition item” indicates a type of the element, and the “post-condition item input value” indicates a value provided to the element. In the uppermost row in the example of FIG. 5, the value (type) of the post-condition item is “heater, set temperature value”. If the “post-condition item input value” is “room A heater 1, 20 degrees”, the post-condition is to set the set temperature of the “room A heater 1” to “20 degrees”. Although the number of post-condition items is two in the example of FIG. 5, the number of post-condition items may be one or may be three or more.

The control rule DB 206 stores control rule information defining the values provided to the element (pre-condition item) included in the pre-condition and the element (post-condition item) included in the post-condition in the basic rule. The control rule information of the control rule DB 206 is combined with the basic rule of the control rule division DB 205 to generate the control rule.

FIG. 6 is a diagram illustrating an example of the control rule information stored in the control rule DB 206. The control rule information in the example of FIG. 6 includes rule divisions, rule subdivisions, user IDs, rule IDs, whether to use the rules, pre-condition item input values, and post-condition item input values.

The rule subdivision is an identifier for more finely classifying the rule division. The rule subdivision may be divided based on the kind of the pre-condition item of the basic rule. For example, the rule subdivision is the same “92-1” in the first to third rows from the top in the example of FIG. 6, and this is a case in which the kind of the “room” in the pre-condition item of the basic rule of the rule division “92” in the example of FIG. 5 is the “living room”. The rule ID is an identifier for distinguishing the control rules. In the example of FIG. 6, the rule ID is indicated by a combination of the rule subdivision and the user ID.

The “whether to use” indicates whether to use the control rule. If “whether to use” is “0” (true), the control rule is used. If “whether to use” is “x” (false), the control rule is not used. The user can set the “whether to use”. However, the present apparatus may automatically set whether to use the control rule according to a value of a degree of recommendation described later.

The pre-condition item input value and the post-condition item input value designate the values of the pre-condition item and the post-condition item (i.e. the value of the element included in the pre-condition and the value of the element included in the post-condition) of the corresponding basic rule, respectively. The corresponding basic rule is specified by the rule division. In the uppermost row of FIG. 6, the rule division is “92”, the pre-condition item input value is “user 1 living room”, and the post-condition item input value is “user 1 living room heater, 20 degrees”. This denotes that the value of the pre-condition item (the value of the element included in the pre-condition) of the basic rule of the rule division “92” in the example of FIG. 5 is designated to “user 1 living room”, and the value of the post-condition item (the value of the element included in the post-condition) is designated to “user 1 living room heater, 20 degrees”.

In this way, the basic rule of the control rule division DB 205 and the control rule information of the control rule DB 206 are combined to construct the control rule. For example, the control rule of the rule ID “92-1-1” is generated by combining the uppermost row of FIG. 6 with the uppermost row of FIG. 5 (rule division is “92”), and the control rule is “set the set temperature of the “user 1 living room heater” to “20 degrees” if the room “user 1 living room” is in an absent state”.

The control rule DB 206 sends, to the control commander 107, the control rule generated based on the control rule information in which the “whether to use” is true. The timing of sending the control rule may be every certain time, may be when the control rule is updated (control rule information is updated), or may be arbitrarily defined. The control commander 107 may perform polling to acquire the control rule from the control rule DB 206. The control rule DB 206 may combine the control rule information in which the “whether to use” is true and the basic rule of the control rule division DB 205 to generate the control rule and hold the control rule in an internal or external memory.

The control commander 107 acquires, from the control rule DB 206, the control rule generated based on the control rule information in which the “whether to use” is true and controls the control target device 103 according to the control rule. As for the acquisition of the control rule, the control commander 107 may perform polling every certain time to acquire the updated control rule or all of the control rules. Alternatively, the control rule DB 206 may transmit the control rule to the control commander 107 when the control rule DB 206 is updated. Although the control rule DB 206 combines the control rule information and the basic rule to generate the control rule here, the control commander 107 may refer to the control rule division DB 205 and the control rule DB 206 to generate the control rule. Note that the control commander 107 may transmit the control rule to the control target device 103, and the control target device 103 may interpret the control rule to operate.

Based on the basic rule of the control rule division DB 205, the control rule information of the control rule DB 206, and the history information of the history storage 201, the matching rate calculator (matching information calculator) 300 calculates matching information indicating a degree that the history information satisfies the pre-condition or the post-condition of the control rule. The matching information also denotes a degree of whether the control rule is to be applied to the control target device 103. Here, a control opportunity occurrence rate (first matching information) and a control content satisfaction rate (second matching information) are calculated as the matching information. Therefore, the matching rate calculator 300 includes a control content satisfaction rate calculator 301 configured to calculate the control content satisfaction rate and a control opportunity occurrence rate calculator 302 configured to calculate the control opportunity occurrence rate. The matching rate calculator 300 generates a control rule from the basic rule and the control rule information and calculates the matching rates (control content satisfaction rate and control opportunity occurrence rate) of the control rule based on the control rule and the history information. The calculated matching rates are sent to the index DB 207. If the control rule generated by the control rule DB 206 is held in a memory, the control rule may be acquired through the control rule DB 206 or may be directly acquired from the memory.

The control content satisfaction rate denotes a ratio of the time or the number of times that the post-condition is satisfied to the time or the number of times that the pre-condition is satisfied. It can be stated that it is desirable to use the control rule when the control content satisfaction rate is high. The control content satisfaction rate can be calculated by, for example, “post-condition satisfaction time (T_POST)”/“pre-condition satisfaction time (T_PRE)”. The “pre-condition satisfaction time” is the time that the pre-condition is true in a certain time. The “post-condition satisfaction time” is the time that both the pre-condition and the post-condition are true in the certain time. Alternatively, the control content satisfaction rate may be calculated by “the number of times that the post-condition is satisfied”/“the number of times that the pre-condition is satisfied”. “The number of times that the pre-condition is satisfied” is the number of times that the pre-condition is true in the certain time, and “the number of times that the post-condition is satisfied” is the number of times that both the pre-condition and the post-condition are true in the certain time.

The control opportunity occurrence rate denotes a value obtained by dividing the time or the number of times that the pre-condition is satisfied in the certain time by a reference time or a reference number of times. An effect of using the control rule related to energy saving or the like can be expected when the control opportunity occurrence rate is high. The time that the pre-condition is true in the certain time is defined as a pre-condition satisfaction time, and the entire measurement time in a day or the like is defined as the reference time. In this case, the control opportunity occurrence rate is obtained by “the pre-condition satisfaction time”/“the reference time”. The number of times that the pre-condition is true in the certain time may be defined as the number of times that the pre-condition is satisfied, and the control opportunity occurrence rate may be obtained by “the number of times that the pre-condition is satisfied”/“the reference number of times”. The reference number of times can be set in advance.

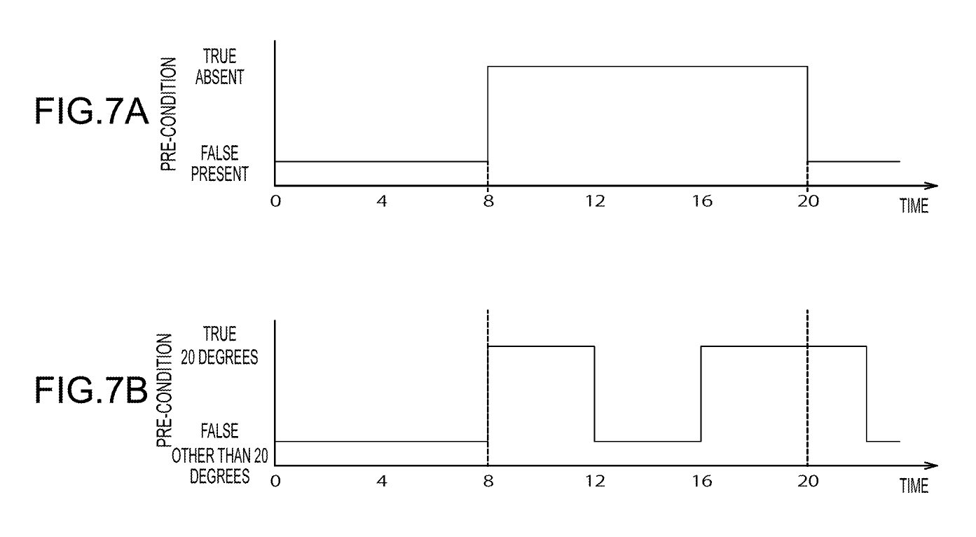

An example of obtaining the control content satisfaction rate for the control rule with the rule ID “92-1-1” will be illustrated. The pre-condition of the control rule is that “the user 1 living room is in the absent state”. The post-condition of the control rule is to “set the set temperature of the user 1 living room heater to 20 degrees”. Here, FIG. 7A illustrates a graph indicating an occupancy status of the user 1 living room of a day. FIG. 7B illustrates a graph indicating whether the set temperature of the heater is 20 degrees in the same day as in the graph illustrated in FIG. 7A. When the certain time is 24 hours, “the time that the pre-condition is true in the certain time” of the day is from 8 o'clock to 20 o'clock, which is twelve hours. “The time that the pre-condition is true and the post-condition is true in the certain time” of the day is from 8 o'clock to 12 o'clock and from 16 o'clock to 20 o'clock, which is eight hours in total, between 8 o'clock and o'clock. As a result, the control content satisfaction rate of the day is 8/12 (about 66%).

A similar example is used to calculate the control opportunity occurrence rate. The time that the pre-condition is true in the certain time is from 8 o'clock to 20 o'clock, which is 12 hours. When the entire time is 24 hours, the control opportunity occurrence rate is 12/24 (50%).

Although two rates, the control content satisfaction rate and the control opportunity occurrence rate, are calculated as the matching rates here, only one of the rates may be calculated. The value of the certain time for calculating the control content satisfaction rate or the control opportunity occurrence rate may be changed according to the control rule. As a result, the matching rates can be calculated according to the activity or the status of the user.

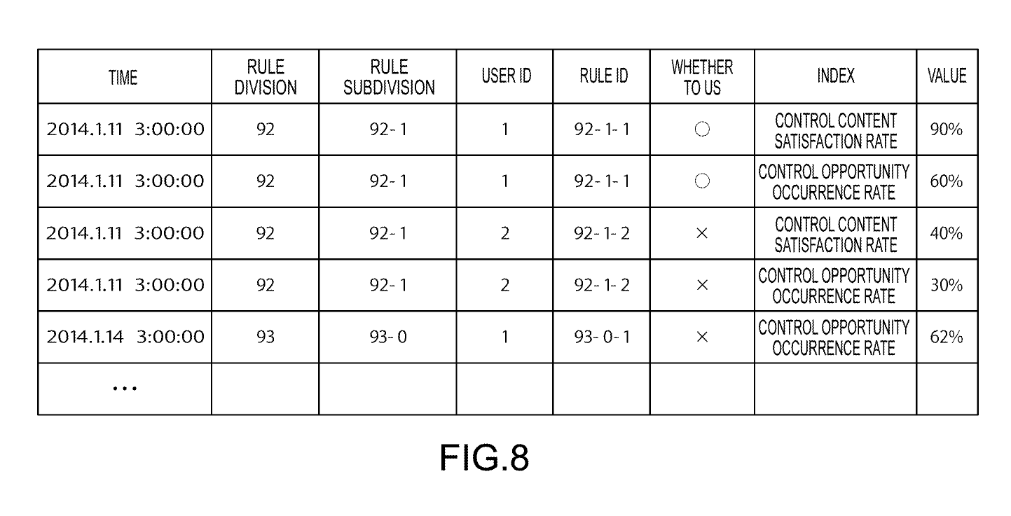

The index DB 207 is a DB configured to store, for each control rule, data of the matching rates (control content satisfaction rate and control opportunity occurrence rate) calculated by the matching rate calculator 300. FIG. 8 illustrates an example of the data stored in the index DB 207. The data in the example of FIG. 8 includes calculation time of the matching rates, rule divisions, rule subdivisions, rule IDs, whether to use the rules, indices indicating the kinds (control content satisfaction rate and control opportunity occurrence rate) of the calculated matching rates, and values of the indices.

The recommender 400 determines whether to recommend the control rule based on the matching rates calculated by the matching rate calculator 300. The determination timing may be every certain time, may be the timing of the update of the index DB 207 after the calculation of the matching rates, or may be arbitrarily defined. The recommender 400 includes a discriminator generator 401 and a whether-to-recommend determiner 402.

The discriminator generator 401 generates a discriminator that outputs a value (degree of recommendation) for determining whether to use the control rule based on the matching rate. A function including the matching rate as an input value can be used as the discriminator. For example, a prediction model can be used, wherein an objective variable Y denotes whether to use the control rule recommended in the past, and an explanatory variable X denotes the matching rate of the recommended control rule. The prediction model associates the explanatory variable X and the objective variable Y. The association of X and Y is expressed by a prediction formula using a plurality of parameters. A regression model, a neural network, LogitBoost, a support vector machine, or the like may be used for the prediction model. Using the prediction model can take into account results recommended up to this time and the like. The discriminator is generated for each rule division. When there are a plurality of kinds of matching rates, such as the control content satisfaction rate and the control opportunity occurrence rate, the discriminator may be generated for each kind of the matching rates, or a discriminator using a plurality of matching rates at the same time may be generated.

The whether-to-recommend determiner 402 uses the discriminator generated by the discriminator generator 401 to calculate the degree of recommendation from the matching rate of the control rule. The whether-to-recommend determiner 402 determines whether to recommend the control rule based on the degree of recommendation. The degree of recommendation may be calculated and determined for all control rules, or the control rules that do not have to be determined may be specified to exclude the control rules from the determination. For example, when “whether to use” the control rule is true, the control rule is already used, and the recommendation may not be determined. The result of the recommendation determination is sent to the recommendation content DB 208 after the determination.

An example of a method of making the determination includes recommending the control rule when the degree of recommendation is equal to or greater than a certain value. A past history may be used, and the control rule may be recommended when the degree of recommendation is over a certain value for a plurality of consecutive times. When there are a plurality of matching rates, such as the control content satisfaction rate and the control opportunity occurrence rate, the results of the determination of each kind of the matching rates may be comprehensively determined. Priorities may be provided for the plurality of matching rates in each control rule, and the determination may be made based only on the matching rate with a high priority. In the determination of the recommendation, not only whether to recommend the control rule, but also various determination results, such as “strongly recommend” the control rule, may be output according to the degree of recommendation.

An example of using a logistic regression model as the discriminator (prediction model) will be described. In the logistic regression model, an objective variable Y can take two logical values, i.e. 0 or 1. When there are N (N is an integer 1 or greater) kinds of explanatory variable, a probability “p” (predicted value) that the objective variable Y is 1 is expressed by a logistic function of the following formula, wherein the explanatory variable of an i-th (i is an integer 1 or greater and N or smaller) kind of explanatory variable is “xᵢ”, and parameters are “aᵢ” and “bᵢ”.

$$p = \frac{1}{1 + exp ( - {\sum }_{i}^{N} {a}_{i} {x}_{i} + {b}_{i} )} \qquad [ Expression 1 ]$$

The logistic function can be used to obtain the probability of using the control rule, wherein the objective variable Y indicates whether to use the control rule, “Y=0” indicates that the control rule is not used, and “Y=1” indicates that the control rule is used. Therefore, to use the logistic function, the discriminator generator 401 calculates optimal values of the parameters “aᵢ” and “bᵢ” of the model formula based on whether to use the control rule recommended in the past and the matching rate at that time. Although there are N kinds of explanatory variables in the formula, there is no problem even if there is only one kind of explanatory variable. Only the control content satisfaction rate may be the explanatory variable, or both of the control content satisfaction rate and the control opportunity occurrence rate may be the explanatory variables. Other matching rates may also be the explanatory variables. In addition, the inside of the parentheses in the above expression will be called a logit value.

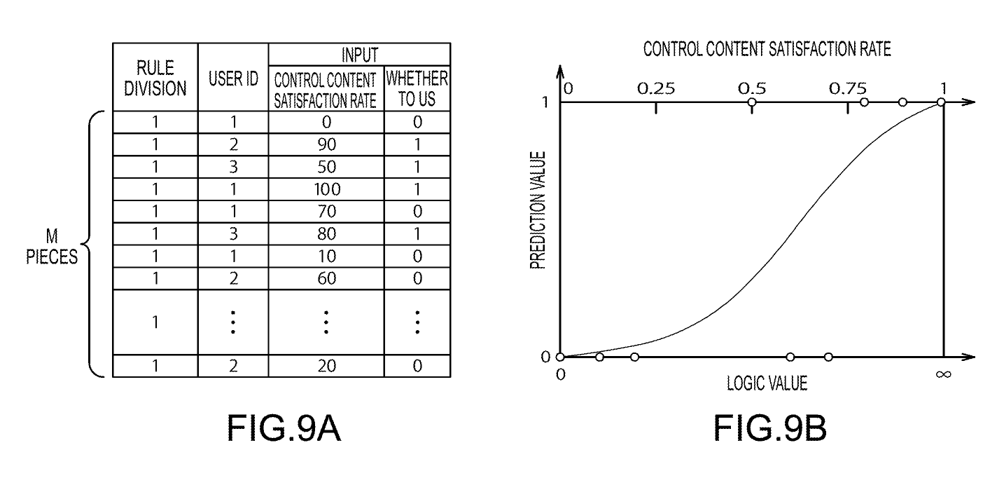

FIGS. 9A and 9B are diagrams for describing the creation of the discriminator. For example, the discriminator generator 401 acquires M (M is an integer 1 or greater) pieces of data with the rule division “1” from the index DB 207 as in FIG. 9A. The discriminator generator 401 regards the explanatory variable as only the control content satisfaction rate and calculates the parameters “a₁” and “b₁” from the M pieces of data such that an output “p” becomes most probable using a maximum likelihood method or the like. As a result, a logistic function “p=1/(1+exp(−(a1X+b1)))” is obtained. The formula represents a curve as in FIG. 9B, wherein the horizontal axis indicates the logit value, and the vertical axis indicates the predicted value. The whether-to-recommend determiner 402 assigns the matching rate calculated by the matching rate calculator 300 to “X” of the formula to calculate the probability “p” where “Y=1”, and the value thereof can be set as the degree of recommendation.

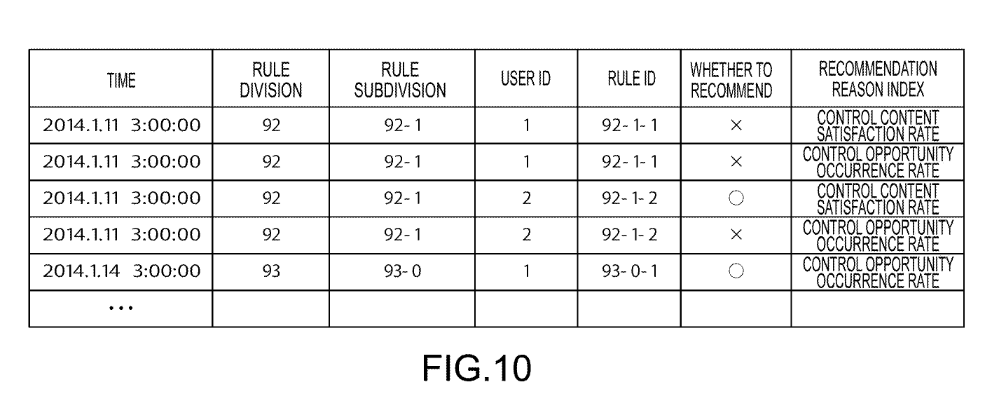

The recommendation content DB 208 stores, for each control rule, the determination result of whether to recommend the control rule sent from the whether-to-recommend determiner 402. FIG. 10 is a diagram illustrating an example of data stored in the recommendation content DB 208. The data in the example of FIG. 10 includes rule divisions, rule subdivisions, user IDs, rule IDs, whether to recommend the rules, recommendation reason indices indicating the kinds of matching rates used to calculate whether to recommend the rules, and the like.

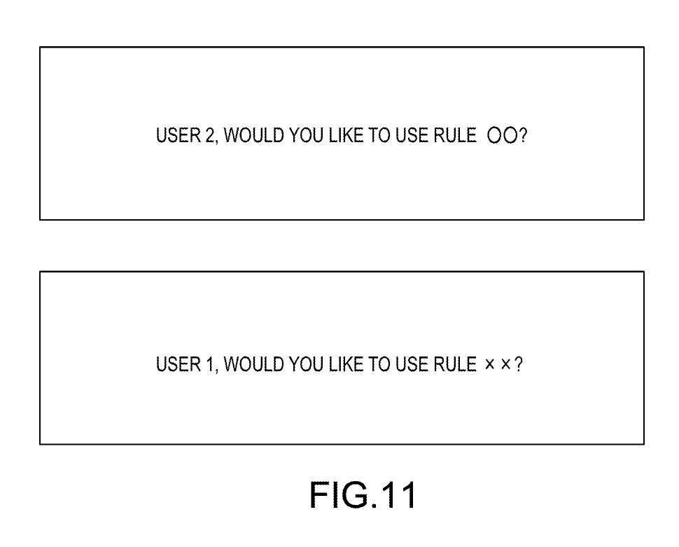

The output device 105 outputs a message related to the recommendation of the control rule based on the “whether to recommend” in the data stored in the recommendation content DB 208. An example of an output method includes a method of displaying a recommendation sentence on an external monitor or the like. An email may be transmitted to an email address of the user registered in advance. FIG. 11 illustrates an example of the recommendation sentence output by the output device 105. The output device 105 may hold the format of the recommendation sentence, or the format may be stored in a DB, such as the control rule DB 206, along with the rule ID. The content of the control rule, the reason of the recommendation, and the like may also be displayed. The displayed sentence may be changed depending on the degree of whether to recommend the control rule, the user ID, the reason of the recommendation, and the like. The timing of outputting the sentences can be when the “whether to recommend” is updated.

The input device 106 receives “whether to use” the control rule from the user through an input interface displayed on an input apparatus or the like. The received “whether to use” is sent to the control rule DB 206. Not only whether to use the control rule, but also a change in the pre-condition item input value or the post-condition item input value of the recommended control rule may be received. The received value is sent to the control rule DB 206, and the control rule information (such as “whether to use”) is updated.

The user may be able to use the output device 105 and the input device 106 to spontaneously access the control rule DB 206 to update “whether to use” the control rule, the pre-condition item input value, and the post-condition item input value.

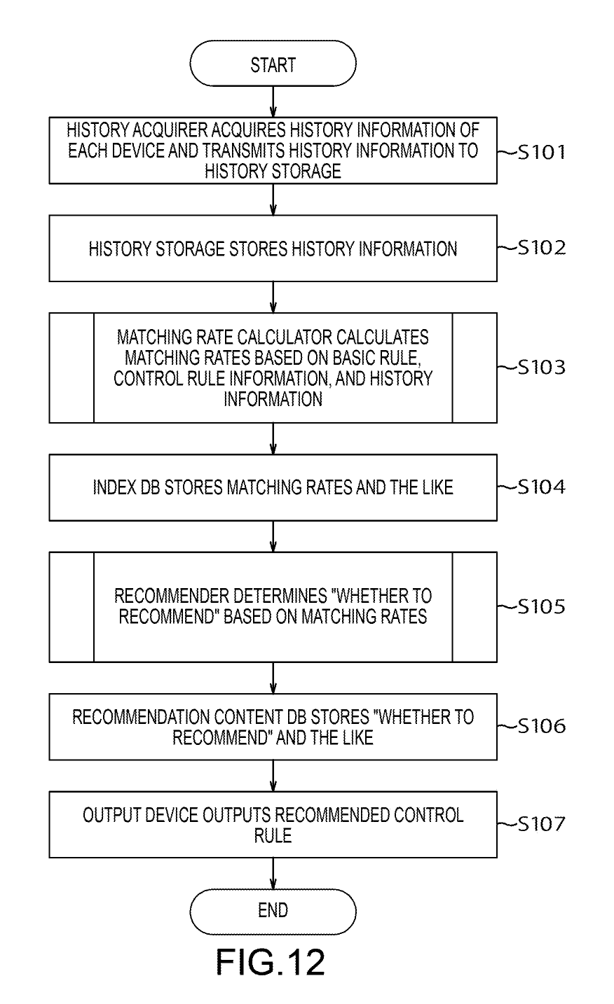

FIG. 12 is a schematic flow chart of a recommendation process in the first embodiment.

The history acquirer 104 acquires the information detected by the user activity detector 101, the environment detector 102, and the control target device 103 and transmits the information to the history storage 201 (S101).

The history storage 201 stores the received information in the activity history DB 202, the environment history DB 203, and the device operation history DB 204 for the user activity detector 101, the environment detector 102, and the control target device 103, respectively (S102).

The matching rate calculator 300 calculates the matching rates based on the basic rule of the control rule division DB 205, the control rule information of the control rule DB 206, and the history information of the history storage 201 (S103).

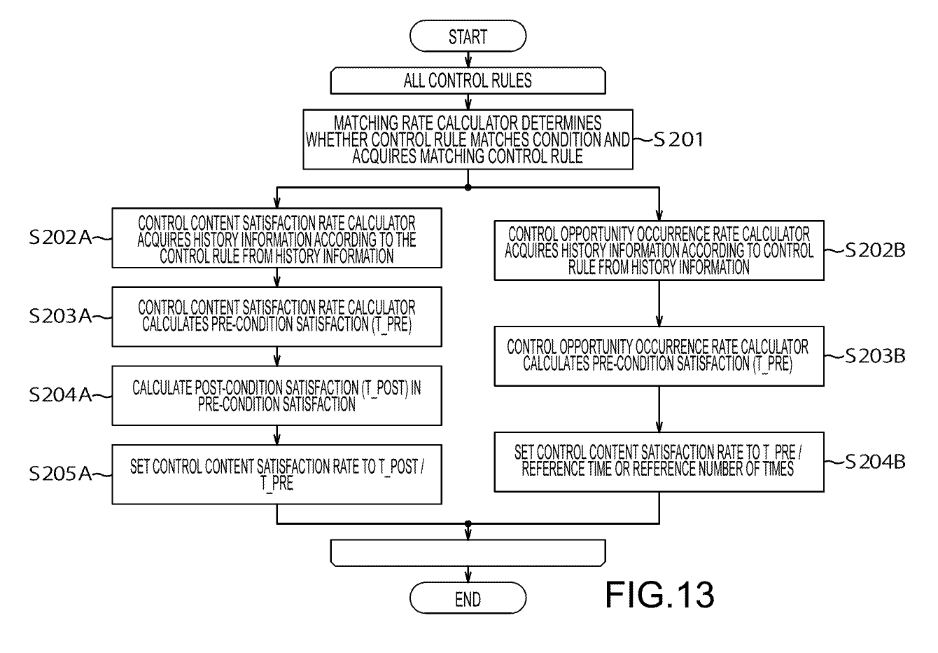

FIG. 13 is a flow chart illustrating details of the process of calculating the matching rates. The matching rate calculator 300 acquires the control rules that match a predetermined condition among all of the control rules (S201). The control rules that do not match the predetermined condition are not acquired, and The control rules that are not acquired are handled as control rules for which whether to use the control rules does not have to be determined, and the following process is not applied. For example, if the “whether to use” is true, the control rule is already used, and whether to recommend the use of the control rule may not be determined. If the season is summer, whether to recommend the use of the control rule may not be determined for the control rules related to heaters. The matching rates of the control rules for only holidays may be obtained from data of holidays, and the process may be applied only to the next days of the holidays. Note that the control content satisfaction rate calculator 301 and the control opportunity occurrence rate calculator 302 may execute the processes, instead of the matching rate calculator 300.

The control content satisfaction rate calculator 301 acquires the history information necessary to calculate the pre-condition satisfaction information (T_PRE) and the post-condition satisfaction information (T_POST) regarding the control content satisfaction rate (S202a).

The control content satisfaction rate calculator 301 calculates the pre-condition satisfaction information (T_PRE) (S203a) and calculates the post-condition satisfaction information (T_POST) (S204a) from the acquired history information as described in FIGS. 7A and 7B. The control content satisfaction rate calculator 301 calculates the control content satisfaction rate from the calculated “T_POST” and “T_PRE” (S205a). Which one of the time and the number of times is to be used to calculate the control content satisfaction rate may be registered in one column of the control rule DB 206.

The control opportunity occurrence rate calculator 302 acquires the history information necessary to calculate the pre-condition satisfaction information from the history storage 201 regarding the control opportunity occurrence rate (S202b).

The control opportunity occurrence rate calculator 302 calculates the pre-condition satisfaction information (T_PRE) from the acquired history information (S203b). The control opportunity occurrence rate calculator 302 calculates the control opportunity occurrence rate from the pre-condition satisfaction information (S204b). For example, the control opportunity occurrence rate calculator 302 calculates the control opportunity occurrence rate based on “T_PRE/reference time” when the pre-condition satisfaction information indicates the time and based on “T_PRE/reference number of times” when the pre-condition satisfaction information indicates the number of times. Note that which one of the reference time and the reference number of times is to be used and the values of the reference time and the reference number of times may be registered in one column of the control rule DB 206.

Although both of the control content satisfaction rate and the control opportunity occurrence rate are calculated in the flow of FIG. 13, only one of the rates may be calculated. Only the control content satisfaction rate may be calculated, or only the control opportunity occurrence rate may be calculated, depending on the control rule.

The index DB 207 stores, for each control rule (each rule ID), the data including the matching rate (control content satisfaction rate or control opportunity occurrence rate) generated by the matching rate calculator 300 (S104).

The recommender 400 determines whether to recommend each control rule based on the matching rate of the data stored in the index DB 207 (S105).

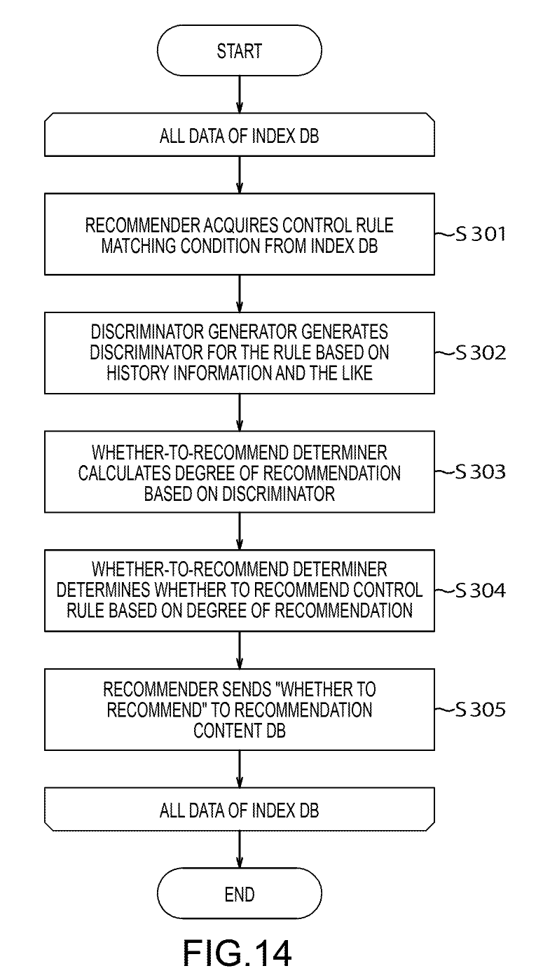

FIG. 14 is a flow chart illustrating details of the process of determining whether to recommend the control rule. The recommender 400 refers to the data stored in the index DB 207 to specify the control rules (rule IDs) satisfying a predetermined condition (S301). An example of the predetermined condition includes that the “whether to use” is false (unused). This is because the control rule in which the “whether to use” is true is already used, and the determination of whether to recommend the control rule is not necessary. A history indicating whether the control rule is recommended in the recommendation process of the last time may be included in the data, and the control rule not recommended the last time may be the condition of selection. This is to prevent an increase in the dissatisfaction of the user when the same control rule is recommended over and over again. The control rule in which the matching rate is most recently updated may be the condition of selection. This is because the control rule in which the matching rate is not updated is a control rule that does not require processing and that is removed in the calculation of the matching rate. An item recording the information referenced to make these determinations may be registered in a column of the control rule DB 206 and the index DB 207.

The discriminator generator 401 generates the discriminators for the specified control rules (S302). The discriminator is generated for, for example, each rule division of the control rules and each kind of the matching rates. For example, when the discriminator is a logistic regression model, there is a method of performing the regression analysis in the discriminator generator 401, wherein the explanatory variable X indicates the matching rate, the objective variable Y indicates whether to use the control rule, “Y=0” indicates that the control rule is not used, and “Y=1” indicates that the control rule is used. In this case, the discriminator generator 401 acquires the history information corresponding to the control rule from the history storage 201 and performs the regression analysis of the history information to calculate the parameters of the logistic function. Note that the discriminator to be calculated may be changed according to the control rule or the kind of the matching rate.

The whether-to-recommend determiner 402 uses the matching rate and the discriminator to calculate the degree of recommendation (S303). For example, in the case of the logistic function, the value “p” of the logistic function is calculated as the degree of recommendation from the matching rate. The value “p” indicates the probability of “Y=1” (probability of using the control rule). Note that other than the probability, the degree of recommendation may indicate an evaluation value, such as a score, depending on the used model.

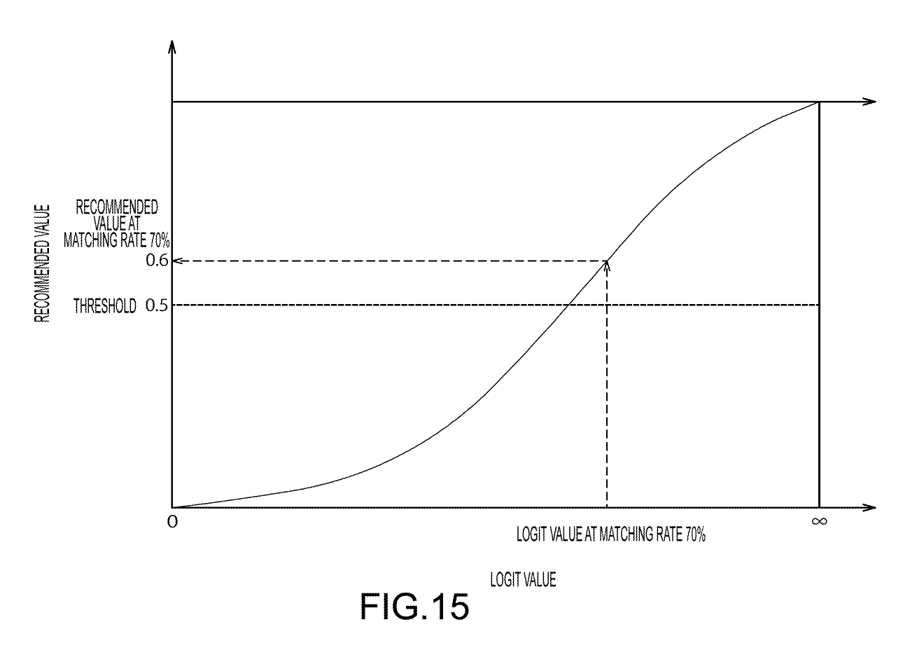

The whether-to-recommend determiner 402 determines whether the control rule can be recommended based on the calculated degree of recommendation (S304). For example, in the case of the logistic function, the whether-to-recommend determiner 402 determines whether the output value (probability) exceeds a threshold. Alternatively, the determination may be made based on time-series variations of the matching rate. The threshold may be changed according to the kind of the used matching rate or the discriminator. Alternatively, the threshold may be changed according to the time-series variations of the matching rate or the like. For example, the threshold can be significantly reduced if the matching rate increases by more than a certain value within a certain period. FIG. 15 is a diagram illustrating a relationship between the probability and the threshold when the discriminator is a logistic regression model. The prediction formula of FIG. 15 indicates that the probability is “0.6” for the “logit value” when the control content satisfaction rate is “70%”. The threshold is “0.5” in the example, and the “whether to recommend” is true (recommended).

The whether-to-recommend determiner 402 sends the determined “whether to recommend” and the information (rule ID, recommendation reason index, and the like) related to the control rule to the recommendation content DB 208 (S305).

The recommendation content DB 208 stores the information received from the whether-to-recommend determiner 402 (S106). Note that, the recommendation content DB 208 may store only the information for the control rules in which the “whether to recommend” is true from all of the received information or may store all of the received information regardless of the “whether to recommend”.

The output device 105 determines whether the column of the “whether to recommend” is true in the recommendation content DB 208 and outputs the information regarding the control rules in which the “whether to recommend” is true. The output device 105 may output the information for all of the control rules without making the determination when only the information for the control rules in which the “whether to recommend” is true is stored in the recommendation content DB 208. When the output device 105 is a monitor, the information is displayed on the monitor. When the output device 105 is a communicator, the information is transmitted to a predetermined address or device determined in advance in the information.

As described, the living activities of each user, the environment, and the operation history of the device are taken into account, and the possibilities of actually using the control rules when the control rules are applied are also taken into account in the first embodiment. The control rules are then selected and recommended to the user. Therefore, the recommended control rules include only control rules that the user can easily permit. This can eliminate the trouble of repeating rejection operation when many control rules not permitted by the user are recommended.

### Second Embodiment

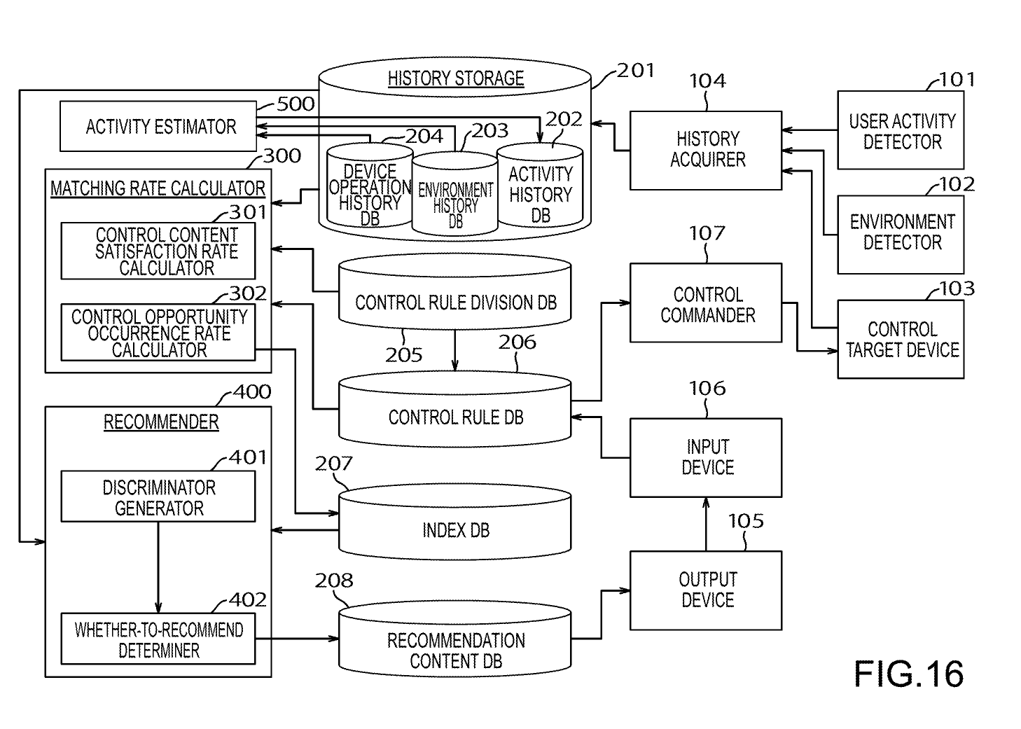

FIG. 16 is a block diagram illustrating a schematic configuration of a recommendation apparatus according to a second embodiment. In the second embodiment, an activity estimator 500 is added to the first embodiment. The description of the same parts and processes as in the first embodiment will not be repeated. The activity estimator 500 will be described.

The activity estimator 500 estimates the activity of the user from the history information of at least one of the environment history DB 203 and the device operation history DB 204 and sends the estimation result to the activity history DB 202. Note that the history information of the activity history DB 202 may be used to increase the accuracy of the estimation. For example, it is found from the history information of the device operation history DB 204 that an IH cooking heater is operated for 30 minutes in a time zone. It is also found from the history information of the environment history DB 203 that the humidity of the kitchen has risen in the same time zone. In this case, the activity estimator 500 estimates that the user was cooking in the time zone. To increase the accuracy of estimation, the activity estimator 500 checks from the activity history DB 202 that the time zone is not a time zone in which nobody was at home. The activity estimator 500 sends the estimation result to the activity history DB 202, and data indicating that a user 2 was cooking is added to the activity history DB 202.

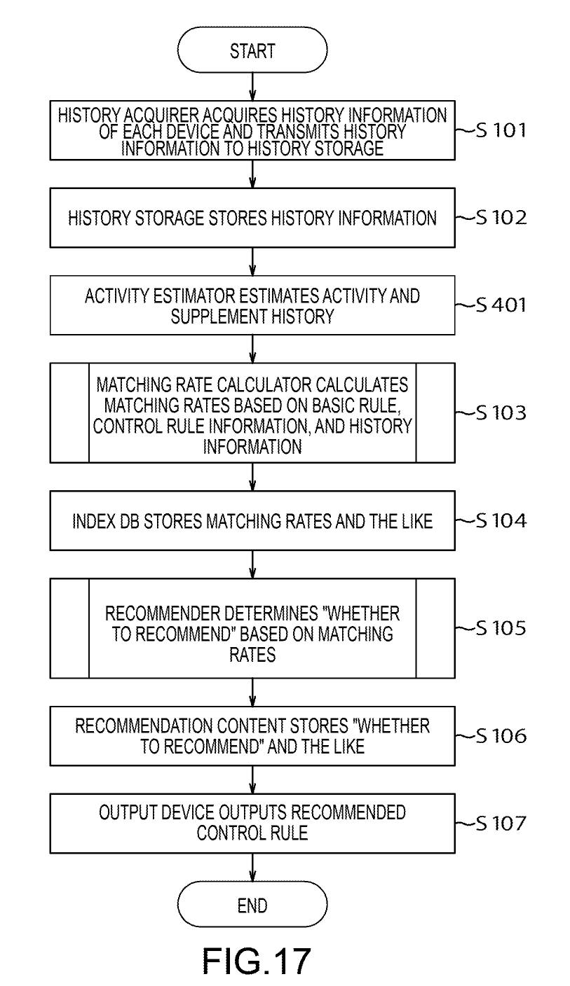

FIG. 17 is a schematic flow chart of a recommendation process in the second embodiment. Step S401 is added between steps S102 and S103 of the first embodiment. In step S401, the activity estimator 500 estimates the activity of the user from data of at least one of the environment history DB 203 and the device operation history DB 204 and adds the data regarding the estimated activity to the activity history DB 202.

An example of an estimation method includes a method of defining in advance an estimated activity and an establishment condition for each device. For example, for the IH cooking heater, the estimated activity can be “cooking”, and the establishment condition can be “the operation time is 30 minutes or more, and the humidity of the operated room has risen in the operation time”. In the example, the activity estimator 500 acquires the history information regarding the IH cooking heater from the device operation history DB 204 and checks the operation time and the operation location. The activity estimator 500 acquires the data of humidity from the environment history DB 203 to check the humidity of the operation location in the time zone. If the condition is satisfied, the activity estimator 500 determines that cooking is the estimated activity, creates data regarding cooking, and sends the data to the activity history DB 202. The activity estimator 500 may hold the data of the estimated activity and the establishment condition. Alternatively, the data may be registered in one column of the DB, such as the device operation history DB 204, as information regarding the device.

As described, according to the second embodiment, information not detected by the user activity detector 101 or insufficient information can be supplied to figure out the activity of the user in more detail than in the first embodiment, and the accuracy of selecting the control rules to be recommended can be increased.

### Third Embodiment

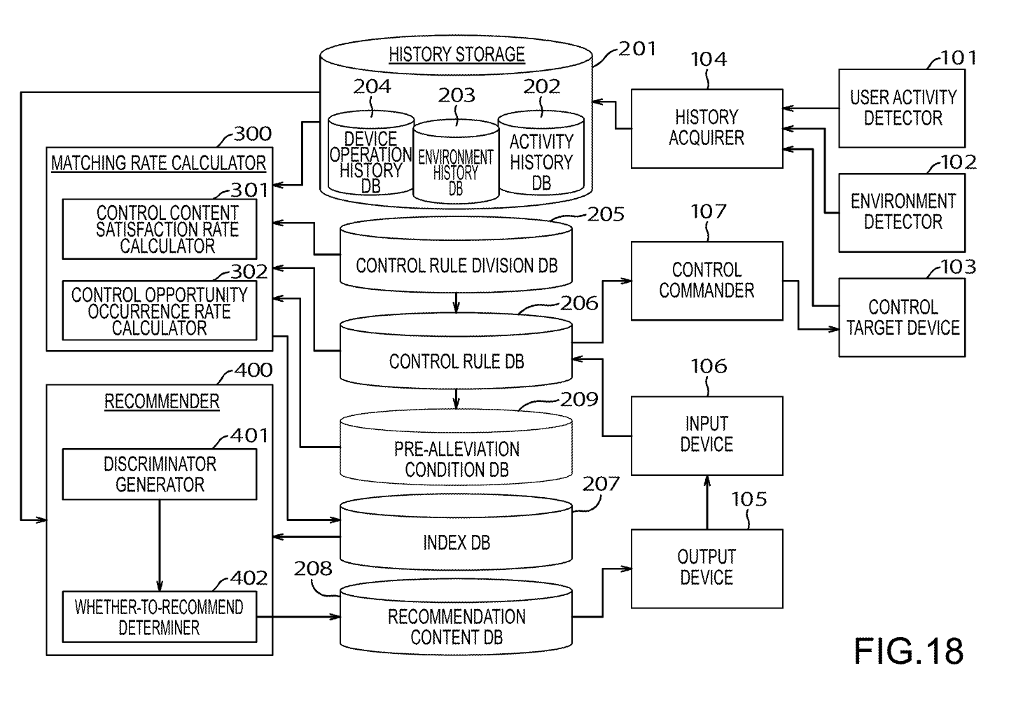

FIG. 18 is a block diagram illustrating a schematic configuration of a recommendation apparatus according to a third embodiment. In the third embodiment, a pre-alleviation condition DB 209 is added to the first embodiment. The description of the same parts and processes as in the first embodiment will not be repeated.

The control content satisfaction rate calculator 301 or the control opportunity occurrence rate calculator 302 acquires the history information that matches the control rule and calculates the pre-condition satisfaction information and the post-condition satisfaction information. If only the history that completely matches the control rule is acquired in the acquisition of the history information, the history slightly out of the control rule is not taken into account at all, and the actual circumstances may not be reflected. Therefore, an alleviation condition is provided in the third embodiment, and the history information that satisfies the alleviation condition is acquired even if the history information does not completely match the control rule.

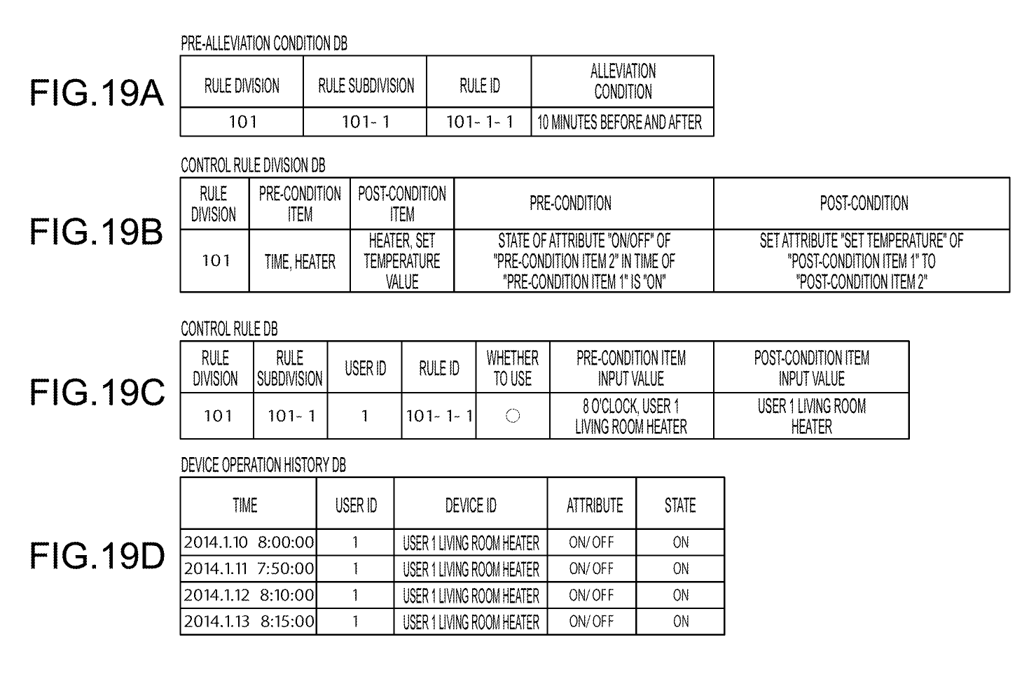

The pre-alleviation condition DB 209 is a DB configured to store the condition (alleviation condition) for alleviating the pre-condition of the control rule. FIGS. 19A to 19D are diagrams illustrating an example of data of the alleviation condition stored in the pre-alleviation condition DB 209. In the example of FIGS. 19A to 19D, items of the stored data include a rule division, a rule subdivision, a rule ID, an alleviation condition, and the like. For example, FIG. 19A illustrates data of an alleviation condition with a rule division “101” and a rule ID “101-1-1”, and the time (“10 minutes before and after”) is the target of alleviation in the alleviation condition. Note that a pre-condition item related to time is included in the rule division “101” as can be understood from the data of the control rule division DB 205 in FIG. 19B. An input value regarding the time of the pre-condition item in the rule ID “101-1-1” is “8 o'clock” as illustrated in the data of the control rule division DB 205 in FIG. 19C. The pre-condition more often becomes true by alleviating “8 o'clock” in the alleviation condition of FIG. 19A. For example, there is only one datum in which the “user 1 living room heater” is “ON” at “8 o'clock” in the example of the data of the device operation history DB 204 in FIG. 19D. There are three data in which the “user 1 living room heater” is “ON” from “7:50” to “8:10”. Therefore, although there is one datum in which the pre-condition is true when there is no alleviation condition, there are three data in which the pre-condition is true when there is the alleviation condition.

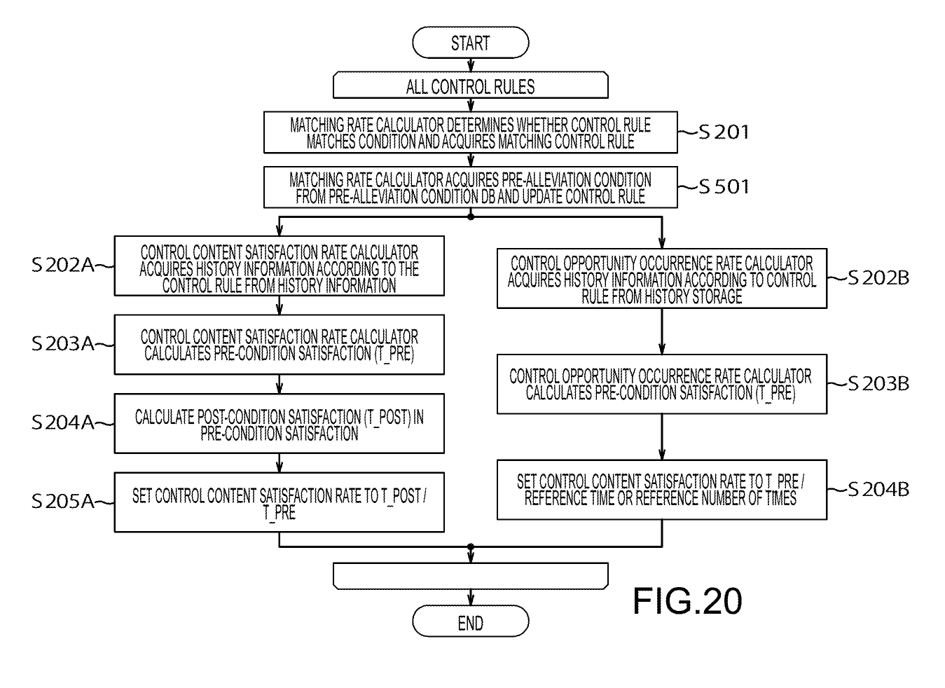

A schematic flow of a recommendation process in the third embodiment is the same as the flow in the first embodiment. FIG. 20 is a flow chart illustrating details of the process of calculating the matching rates in the third embodiment. Step S501 is added after step S201. In step S501, the alleviation condition is acquired from the pre-alleviation condition DB 209, and the control rule acquired in step S201 is updated to alleviate the pre-condition by the alleviation condition (S501). The control content satisfaction rate calculator 301 and the control opportunity occurrence rate calculator 302 receive the updated control rule, and the same process as in the first embodiment is executed.

Although the matching rate calculator 300 refers to the pre-alleviation condition DB 209 to execute the process of updating the control rule in the present flow chart, the pre-alleviation condition DB 209 or another DB may combine the alleviation condition and the control rule in advance to update the control rule, and the matching rate calculator 300 may use the combined control rule.

As described, according to the third embodiment, the pre-condition can be alleviated to more flexibly figure out the real life of the user. A plurality of alleviation conditions with different parameters, such as the region where the user lives and the period or the season in which the condition is applied, can be saved in the alleviation condition DB, and the alleviation condition to be used can be switched according to the region, the period, and the like to easily manage or change (alleviate) the pre-conditions.

### Fourth Embodiment

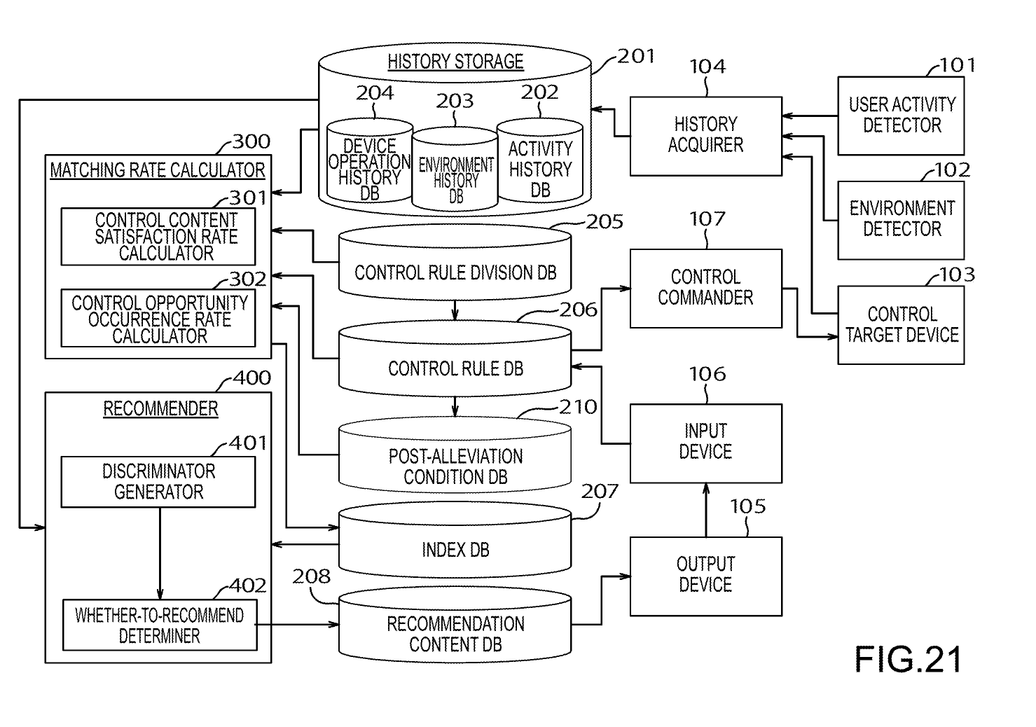

FIG. 21 is a block diagram illustrating a schematic configuration of a recommendation apparatus according to a fourth embodiment. In the fourth embodiment, the pre-alleviation condition DB 209 in the third embodiment is replaced with a post-alleviation condition DB 210. The description of the same parts and processes as in the first and third embodiments will not be repeated.

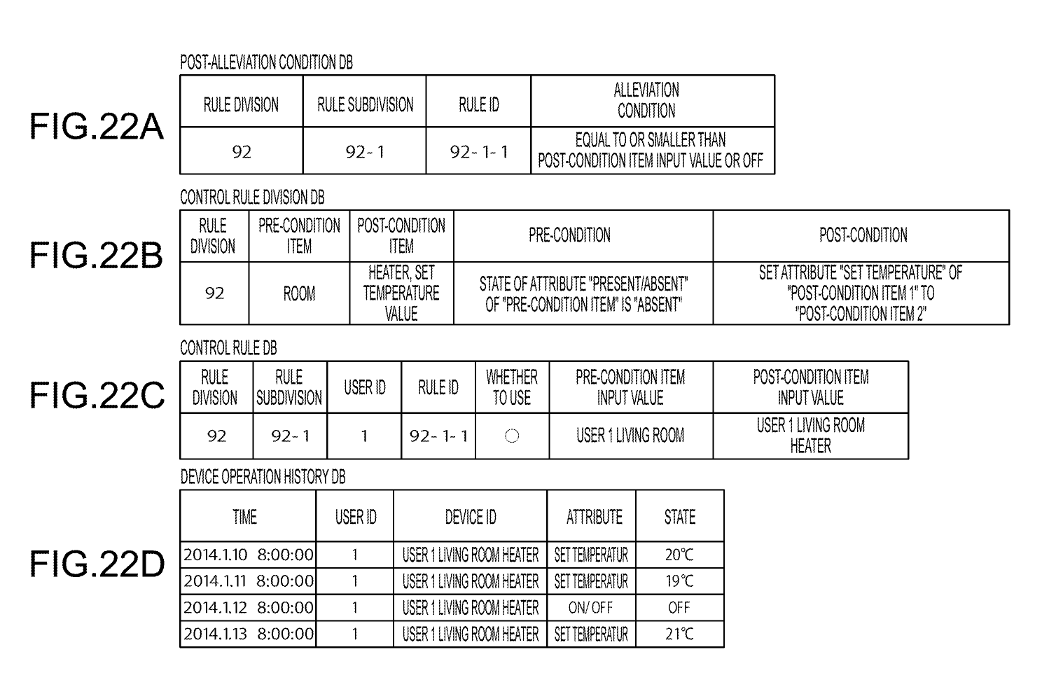

The post-alleviation condition DB 210 is a DB configured to store a condition (alleviation condition) for alleviating the post-condition of the control rule. FIG. 22A is a diagram illustrating an example of data of the alleviation condition stored in the post-alleviation condition DB 210. In the example of FIG. 22A, items of the stored data include a rule division, a rule subdivision, a rule ID, an alleviation condition, and the like. In the example of FIGS. 22A to 22D, the alleviation condition is “equal to or smaller than post-condition item input value or OFF”. The post-condition item input value is “user 1 living room heater, degrees” based on the control rule DB of FIG. 22C. Therefore, the condition (post-condition after alleviation) is satisfied when the “user 1 living room heater” is equal to or lower than 20 degrees or is turned off. In the example of the data of the device operation history DB 204 in FIG. 22D, there is only one datum in which the “user 1 living room heater” is 20 degrees. However, there are three data in which the “user 1 living room heater” is equal to or lower than 20 degrees or is turned off. Therefore, there is one datum in which the post-condition is true when there is no alleviation condition, and there are three data in which the post-condition is true when there is the alleviation condition.

A schematic flow of a recommendation process in the fourth embodiment is the same as the flow chart in the first embodiment. A flow illustrating details of the process of calculating the matching rates is equivalent to a flow in which the pre-alleviation condition DB is replaced with the post-alleviation condition DB in step S501 of the flow chart of FIG. 20 in the third embodiment.

As described, according to the fourth embodiment, the post-condition can be alleviated, and the same effects as in the third embodiment can be obtained.

### Fifth Embodiment

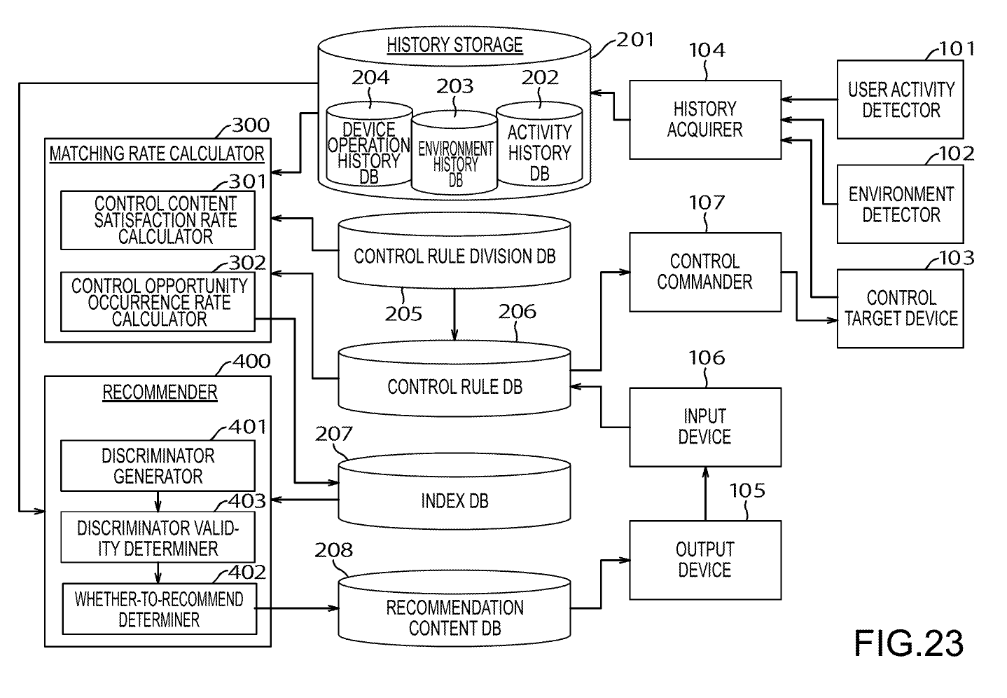

FIG. 23 is a block diagram illustrating a schematic configuration of a recommendation apparatus according to a fifth embodiment. In the fifth embodiment, the recommender 400 further includes a discriminator validity determiner 403.

The discriminator validity determiner 403 determines the validity of the discriminator generated by the discriminator generator 401. An example of a method of determining the validity may include a method of using a coefficient of determination R².

The coefficient of determination R² indicates a matching degree of the regression formula calculated by the regression analysis and the actual relationship. The coefficient of determination R² is also called a contribution ratio. As described, the prediction model associates the explanatory variable X and the objective variable Y, and the discriminator generator 401 calculates the parameters of the prediction model based on a plurality of data. The coefficient of determination R² denotes likelihood (accuracy) of the parameter. The closer the coefficient of determination R² to 1, the higher is the accuracy of the parameter, and it can be determined that the discriminator is valid.

An example of obtaining the coefficient of determination R² will be described. As described in the example of FIGS. 9A and 9B, it is assumed that there is one kind of explanatory variable, i.e. control content satisfaction rate, and the parameters “a₁” and “b₁” are calculated from M pieces of data to obtain the prediction formula “p=1/(1+exp−(a₁X+b₁))”. First, The discriminator validity determiner 403 obtains a likelihood function. The likelihood function indicates accuracy of the used regression model. Although there are many prediction models other than the logistic regression model, the likelihood function indicates the likelihood of whether the prediction model is a model suitable for indicating the relationship between X and Y. The discriminator validity determiner 403 prepares T (T is an integer 1 or greater) pieces of data of the combination of the control content satisfaction rate and the “whether to use” and assigns the data to the prediction formula to calculate predicted values “p”. A k-th likelihood function “Iₖ” is expressed by the following formula, wherein a k-th predicted value among the obtained T predicted values is “pₖ”, the assigned control content satisfaction rate assigned in this case is “xₖ”, and the “whether to use” in this case is “yₖ”.

lᵢ(xᵢ,yᵢ=pᵢ^{y}^{ᵢ}(1−pᵢ)^{l-y}^{ᵢ}⁾ [Expression 2]

A logarithm of the likelihood function “Iᵢ” is “Lᵢ”, and a logarithm likelihood function “L1” for all combinations from “i=1” to “i=N” can be expressed by the following formula.

$$\begin{matrix}L 1 = {{\sum }_{i}}^{N} log l , ( {x}_{i} , {y}_{i} ) \\ = {{\sum }_{i}}^{N} log \{ {{p}_{i}^{{y}_{i}} ( 1 - {p}_{i} )}^{( 1 - {y}_{i} )} \} \\ = {{\sum }_{i}}^{N} \{ {y}_{i} log {p}_{i} + ( 1 - {y}_{i} ) log ( 1 - {p}_{i} ) \} \\ = {{\sum }_{i}}^{N} {y}_{i} log {p}_{i} + {{\sum }_{i}}^{N} ( 1 - {y}_{i} ) log ( 1 - {p}_{i} )\end{matrix} \qquad [ Expression 3 ]$$

Among the three parameters “aᵢ”, “xᵢ”, and “bᵢ” included in the prediction formula “p=1/(1+exp(−(a1X+b1)))”, the prediction model with only “bᵢ” that is not affected by the explanatory variable is called a null model. The logarithm likelihood function in the case of the null model is “L0”. The predicted value of the null value is “p0ᵢ”, and “p0i” and “L0” can be expressed by the following formulas.

$$\begin{matrix}p {0}_{i} = \frac{1}{1 + exp ( - {\sum }_{i}^{N} {b}_{i} )} & [ Expression 4 ] \\ L 0 = {{\sum }_{i}}^{N} {y}_{i} log p {0}_{i} + {{\sum }_{i}}^{N} ( 1 - {y}_{i} ) log ( 1 - p {0}_{i} ) & [ Expression 5 ]\end{matrix}$$

The coefficient of determination R² can be expressed by using “L1” and “L0” described above. Although there are many coefficients of determination R², any coefficient of determination R² may be used, such as R² of McFadden, R² of Cox & Snell, and R² of Negelkerke. The following formula illustrates a formula of R² of Negelkerke as an example.

$${R}^{2} = \frac{1 - exp \{ - \frac{2}{n} ( L 1 - L 0 ) \}}{1 - exp ( \frac{2}{n} L 0 )} \qquad [ Expression 6 ]$$

The discriminator validity determiner 403 compares the coefficient of determination R² calculated in this way and the reference value held in advance to make the determination. The discriminator validity determiner 403 can determine that the discriminator is qualified (valid) if the coefficient of determination R² is greater than a reference value and can determine that the discriminator is disqualified (invalid) if the coefficient of determination R² is equal to or smaller than the reference value.

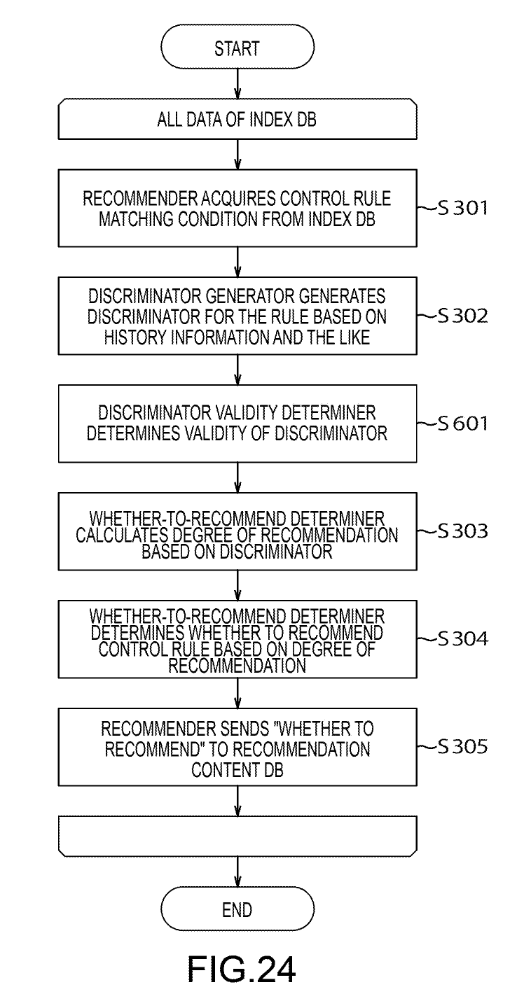

A schematic flow of a recommendation process in the fifth embodiment is the same as in the first embodiment. FIG. 24 is a flow chart illustrating details of the process of the whether-to-recommend determination in the fifth embodiment. Step S601 is added between steps S302 and S303 of the flow chart of FIG. 14 in the first embodiment.

The discriminator validity determiner 403 determines the validity of the discriminator generated by the discriminator generator 401 (S601). The process after the determination that the discriminator is qualified is the same as in the first embodiment. If the discriminator is disqualified in the determination, the entire process may be stopped, or the process by the recommender 400 regarding the control rule may be stopped to move the process to the next control rule. Alternatively, the process may be returned to the discriminator generator 401, and a discriminator may be created again by another method. Alternatively, the whether-to-recommend determiner 402 may be caused to use the discriminator used in the last time again.

The determination method, the kind of the coefficient of determination R², the reference value of the determination, and the like may be held in the discriminator validity determiner 403 or the discriminator generator 401 or may be registered in a DB, such as the index DB 207. The determination method, the kind of the coefficient of determination R², the reference value of the determination, and the like may be changed for each control rule or discriminator.

As described, according to the fifth embodiment, the control rule is recommended after the validity of the discriminator is determined. Therefore, the accuracy of recommending an optimal control rule can be higher than in the first embodiment.

### Sixth Embodiment

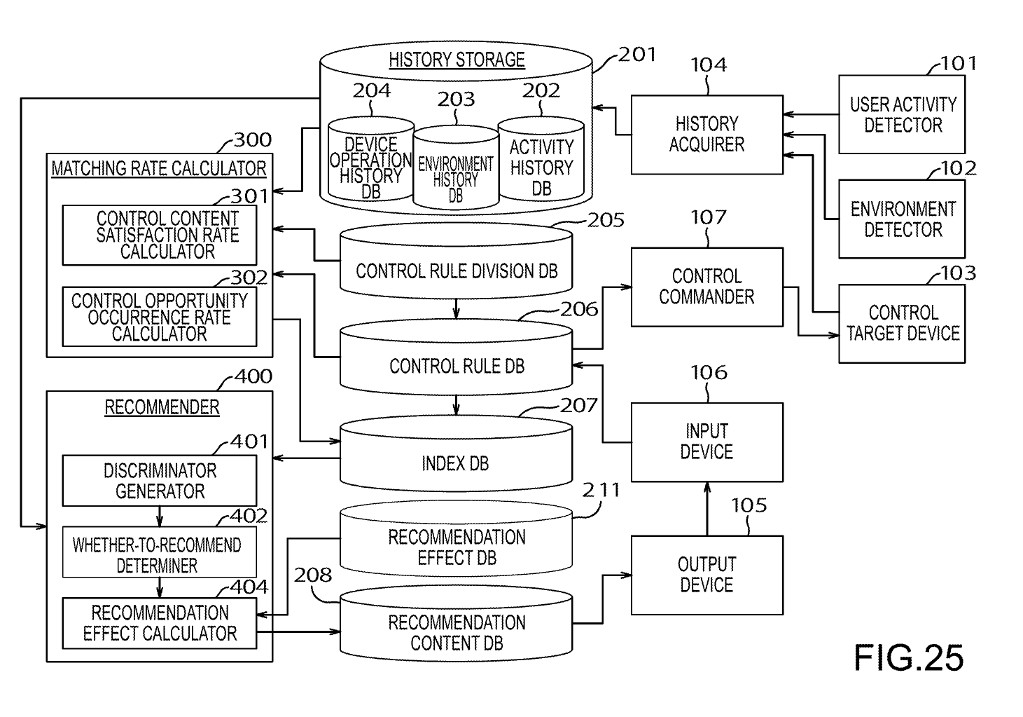

FIG. 25 is a block diagram illustrating a schematic configuration of a recommendation apparatus according to a sixth embodiment. In the sixth embodiment, a recommendation effect DB 211 is added to the first embodiment, and a recommendation effect calculator 404 is provided on the recommender 400.

The recommendation effect DB 211 is a DB configured to store recommendation effect calculation methods regarding the matching rates (such as the control content satisfaction rate and the control opportunity occurrence rate) for each rule ID. The recommendation effect is an effect of reducing an electricity bill, a power saving effect, or the like when the control rule is applied.

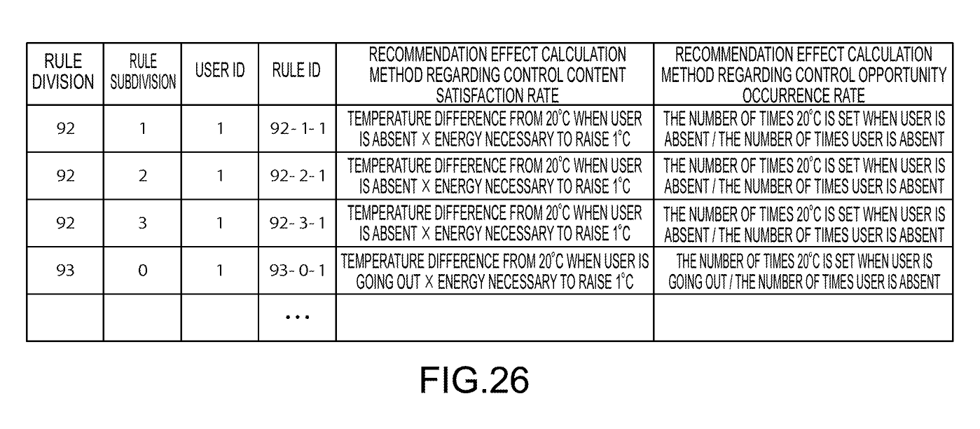

FIG. 26 is a diagram illustrating an example of data stored in the recommendation effect DB 211. The example of FIG. 26 includes a recommendation effect calculation method or the like of each kind of matching rate for each rule ID.

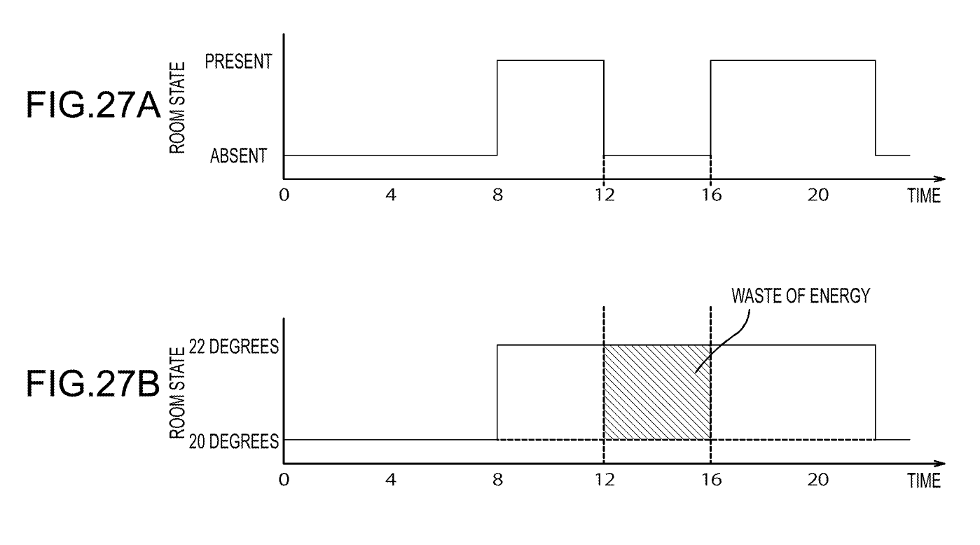

An example of calculating the recommendation effect from the recommendation effect calculation method of FIG. 26 will be illustrated. FIG. 27A illustrates a graph of an occupancy state of a room. It can be recognized that the user is absent from 12 o'clock to 16 o'clock. FIG. 27B illustrates a graph of a room temperature state of the room. It can be recognized that the room temperature is maintained at 22 degrees from 8 o'clock to o'clock. If a rule ID “92-1-1” of FIG. 26 for setting the heater to 20 degrees when the user is absent is applied, waste of energy that the heater raises the room temperature by two degrees during the four hours in which the user was absent would have been eliminated. The energy that can be saved in this case can be a recommendation effect.

For each control rule received from the whether-to-recommend determiner 402, the recommendation effect calculator 404 acquires the history information regarding the control rule from the history storage 201. The recommendation effect calculator 404 also acquires the recommendation effect calculation method corresponding to the kind of matching rate (control content satisfaction rate or control opportunity occurrence rate) of the control rule from the recommendation effect DB 211. The recommendation effect calculator 404 calculates the recommendation effect based on the acquired history information and recommendation effect calculation method and sends the recommendation effect to the recommendation content DB 208.

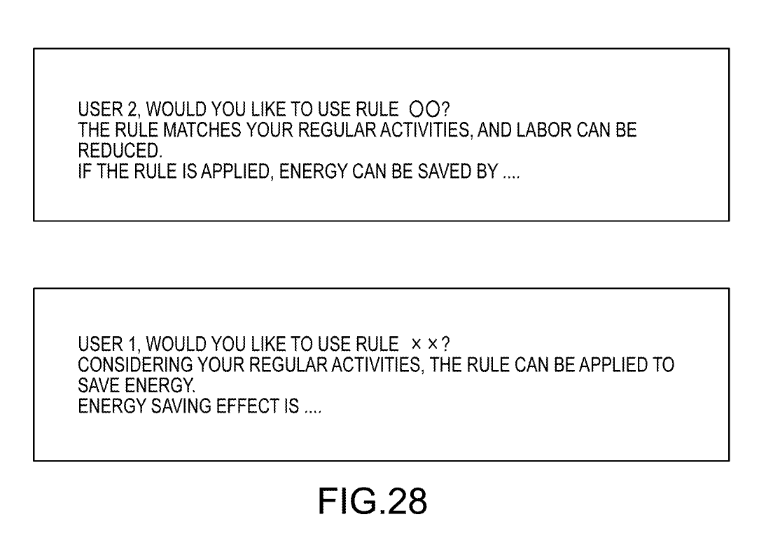

A column of the recommendation effect is newly added to the recommendation content DB 208. The output device 105 outputs a display using a result of the recommendation effect. FIG. 28 illustrates an example of recommendation sentences output by the output device 105 using the result of the recommendation effect. The reason and the effect, such as reduction of labor by automation and energy saving, can be more clarified compared to the recommendation sentences of the first embodiment, and there is an effect that the user can easily accept the recommendation.

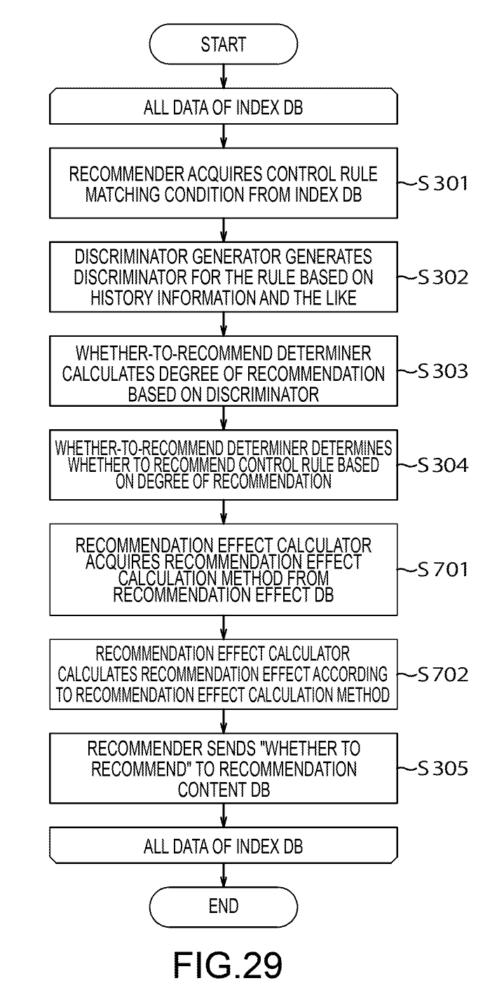

A schematic flow of the recommendation process in the sixth embodiment is the same as in the first embodiment. FIG. 29 is a flow chart illustrating details of the process of whether-to-recommend determination in the sixth embodiment. Steps S701 and S702 are added between steps S304 and S305 of the flow chart of FIG. 14 in the first embodiment. In step S701, the recommender 400 acquires the recommendation effect calculation methods from the recommendation effect DB 211. In step S702, the recommender 400 calculates the recommendation effects for the rules for which whether to recommend is determined. To reduce the calculation time, the recommendation effects may be calculated only when the “whether to recommend” is true (recommended). In the present flow chart, the recommendation effects of the determined control rules are immediately calculated, and the recommendation effect of each control rule is sent to the recommendation content DB 208. However, the present flow chart is an example, and the flow chart can be changed variously. For example, the processes by the recommendation effect calculator 404 (S701 and S702) and the process by the recommender 400 sending the “whether to recommend” to the recommendation content DB 208 (S305) may be executed in parallel. In addition, the recommendation effects may be calculated after the end of the whether-to-recommend determination of all rules.

As described, according to the sixth embodiment, the effects of applying the recommended control rules become clearer than in the first embodiment. Therefore, the possibility of the user approving the control rules and the satisfaction of the user can be higher in the first embodiment.

### Seventh Embodiment

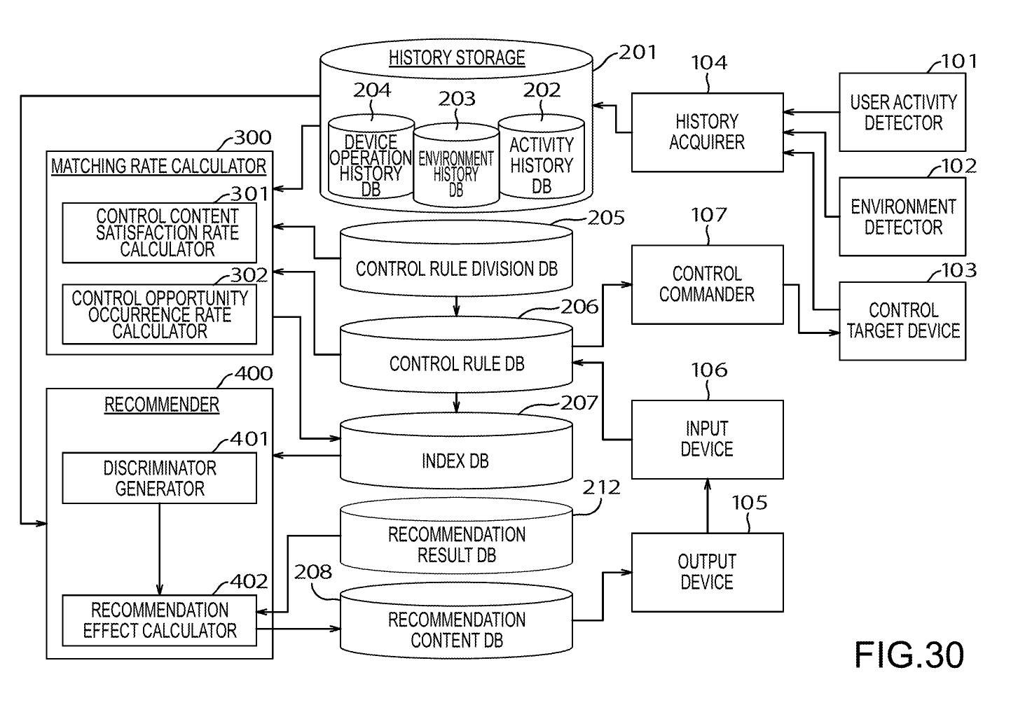

FIG. 30 is a block diagram illustrating a schematic configuration of a recommendation apparatus according to a seventh embodiment. In the seventh embodiment, the recommendation result DB 212 is added to the first embodiment.

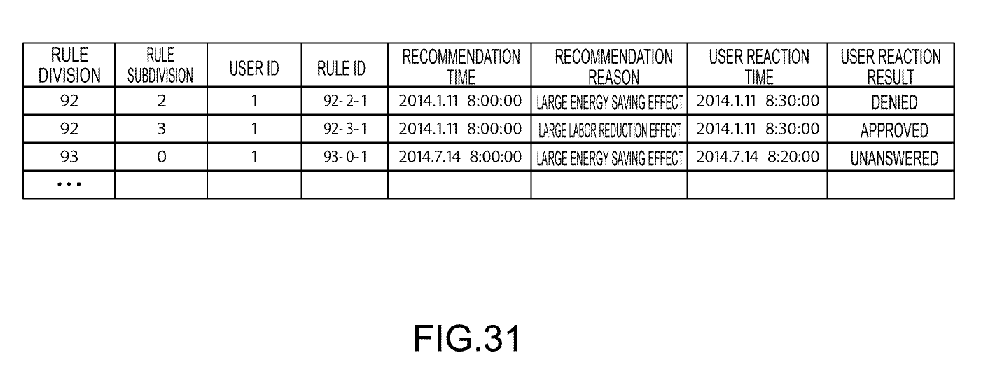

The recommendation result DB 212 is a DB configured to store results of reaction of the user for the control rules recommended to the user. Reasons that the control rules are recommended to the user may also be stored (reasons of recommendation can be determined by the same method as in the sixth embodiment). FIG. 31 illustrates an example of data stored in the recommendation result DB 212. The stored data includes time of recommendation, reasons of recommendation, user reaction time, and user reaction results in addition to rule divisions, rule subdivisions, user IDs, and rule IDs.

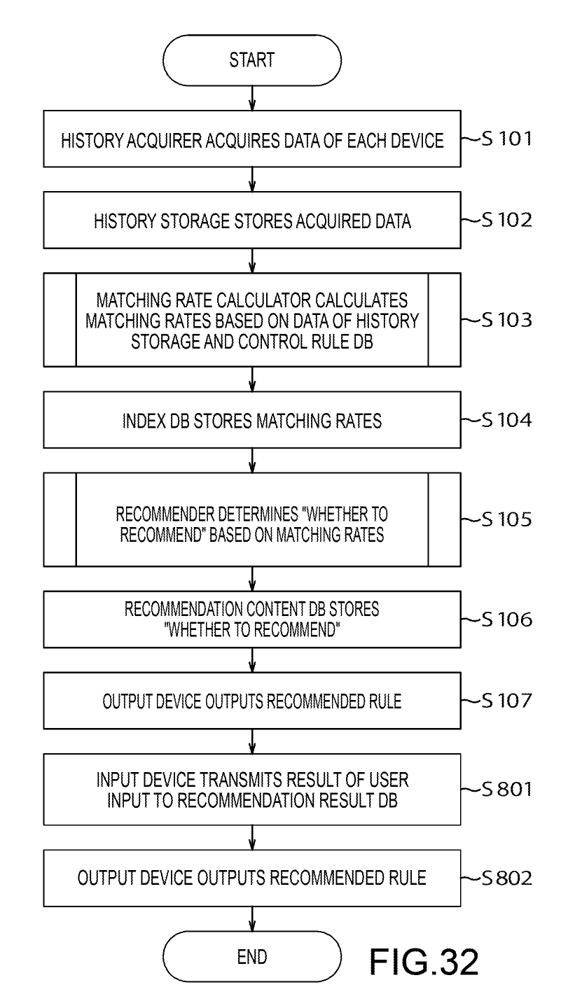

FIG. 32 is a schematic flow chart of a recommendation process in the seventh embodiment. Steps S801 and S802 are added after step S107 of the flow chart of FIG. 12 in the first embodiment. After the output device 105 outputs the recommended control rules in step S107, the input device 106 receives answers from the user. The input device 106 sorts reaction results of the user for the recommended rules into a plurality of kinds indicating approval, denial, no response, and the like and sends the reaction results to the recommendation result DB 212 (S801).

The recommendation result DB 212 stores the data therein based on the input information from the input device 106 (S802).

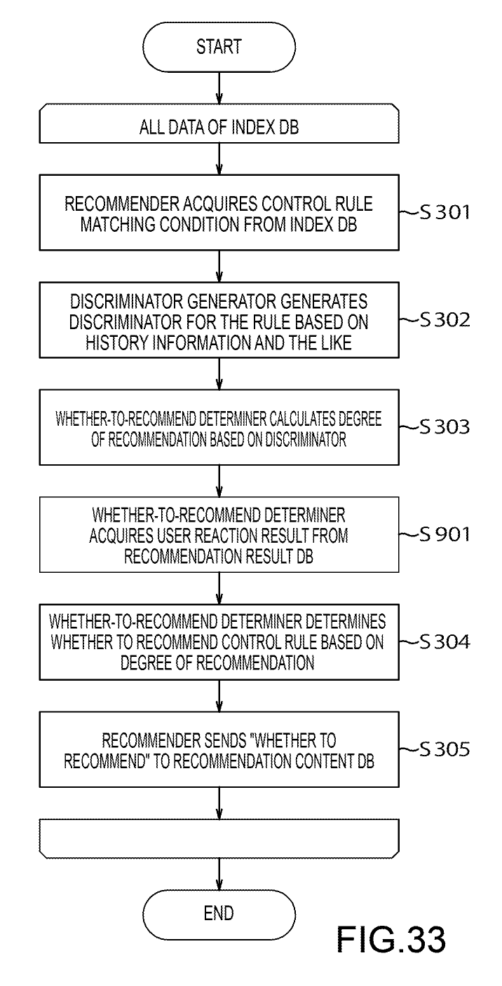

FIG. 33 is a flow chart illustrating details of the process of whether-to-recommend determination in the seventh embodiment. Step S901 is added between steps S303 and S304 of the flow chart of FIG. 14 in the first embodiment. After the calculation of the degree of recommendation (S303), the whether-to-recommend determiner 402 acquires the user reaction result from the recommendation result DB 212 (S901). If the user reaction result indicates denial, the whether-to-recommend determiner 402 determines not to recommend the control rule until after a certain time (or not to execute the process of determining whether to recommend the control rule).

As described, according to the seventh embodiment, the disapproved control rules are unlikely to be recommended from the next time, and the satisfaction of the user can be higher than in the first embodiment.

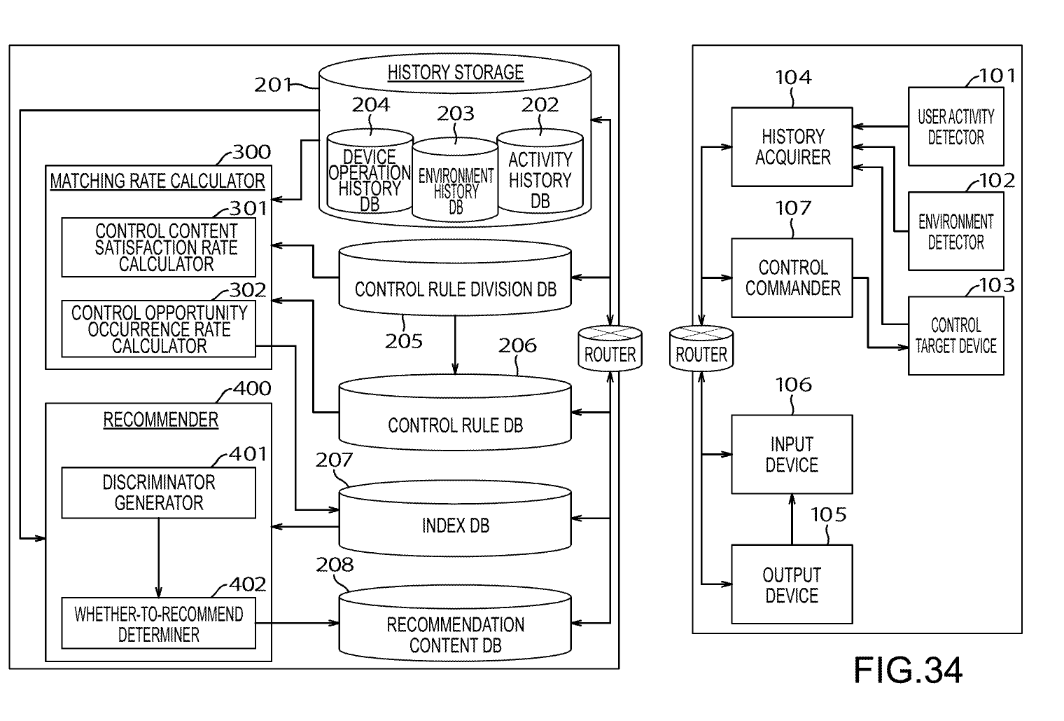

Note that part of the apparatus configuration of the embodiments illustrated above can be separated from the apparatus to arrange the part as another apparatus on a network. FIG. 34 illustrates a case of dividing the components in the first embodiment into a monitoring environment side and a service providing environment side. The user activity detector 101, the environment detector 102, the control target device 103, the history acquirer 104, the output device 105, the input device 106, and the control commander 107 are placed in a monitoring environment such as a house. The history storage 201, the DBs such as the control rule DB 206, the matching rate calculator 300, the recommender 400, and the like are placed in a service providing environment on a communication network such as cloud. The monitoring environment side and the service environment side are connected through a gateway (router) and the communication network. Each of the history acquirer 104, the output device 105, the input device 106, and the control commander 107 in the monitoring environment may be an individual apparatus.

In this way, only minimum required devices are arranged in the monitoring environment, and the DBs and the arithmetic processing unit use resources on the network. As a result, the system can attain excellent availability, serviceability, and confidentiality. Furthermore, monitoring results of a plurality of home environments can be reflected on the system, and the recommendation effects of applying the control rules can be increased.

The processes in the embodiments illustrated above can be realized by software (program). Therefore, the recommendation apparatuses in the embodiments described above can be realized by using a general-purpose computer device as basic hardware and causing a processor 501 mounted on the computer device to execute the program.

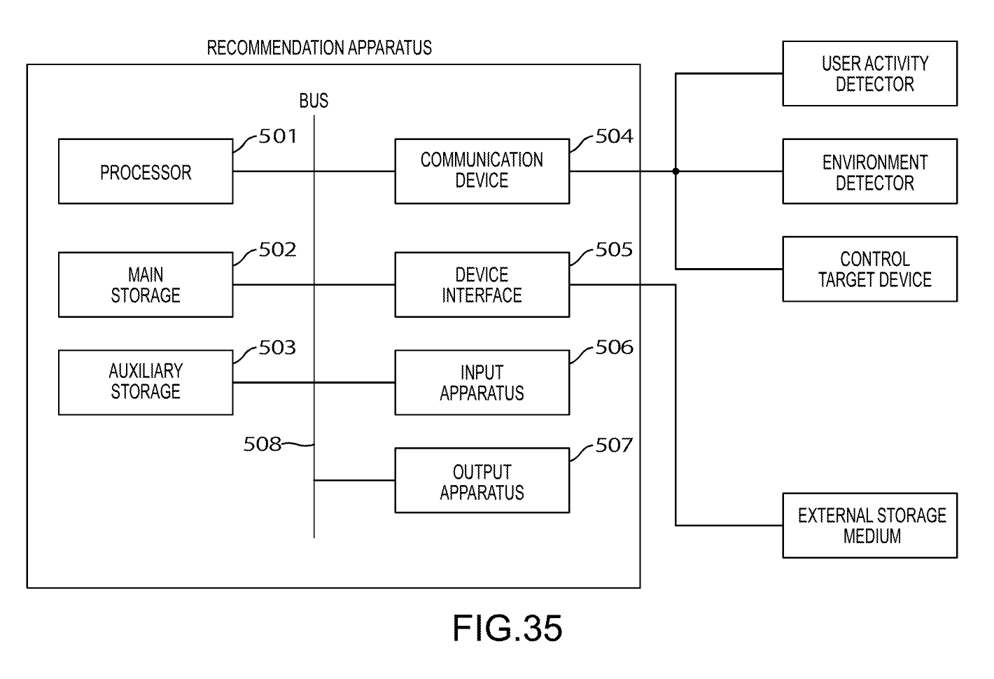

FIG. 35 is a diagram illustrating an example of hardware configuration of the recommendation apparatus according to the embodiments of the present invention.

The recommendation apparatus includes the processor 501, a main storage 502, an auxiliary storage 503, a communication device 504, a device interface 505, an input apparatus 506, and an output apparatus 507. The components are connected through a bus 508, and the recommendation apparatus can be realized as a computer device.

The processor 501 can read a program from the auxiliary storage 503 and expand the program in the main storage 502 to execute the program to thereby realize the functions of the history acquirer 104, the control commander 107, the matching rate calculator 300, the recommender 400, the activity estimator 500, the output device 105, the input device 106, and the like.

The program executed by the recommendation apparatus may be installed in advance in the computer device to realize the recommendation apparatus of the present embodiment. The program may be stored in a storage medium, such as a CD-ROM, or the program may be distributed through a network. The program may be appropriately installed on the computer device to realize the recommendation apparatus of the present embodiment.

The communication device 504 is a device including communication means, such as Ethernet (registered trademark), wireless LAN (Local Area Network), Bluetooth (registered trademark), ZigBee (registered trademark), and KNX (registered trademark), and configured to perform communication for acquiring data from the user activity detector 101, the environment detector 102, and the control target device 103. The communication performed by the history acquirer 104 and the control commander 107 are performed through the communication device 504. When the DB of the history storage 201 and the like is an NAS (Network Attached Storage), a DB server, or the like and is connected to the recommendation apparatus through a communication line, the data is transmitted and received through the communication device 504.

The device interface 505 is an interface connected to a device, such as an external storage medium like a SAN (Storage Area Network). When a display apparatus and the input apparatus 506, such as a display and a keyboard, are on the outside of the recommendation apparatus, the device interface 505 may also be connected to the display apparatus and the input apparatus 506.

The input apparatus 506 includes a user input interface, such as a keyboard and a mouse, and outputs an operation signal based on operation of the user input interface to the processor 501.

The output apparatus 507 includes a display, such as an LCD (Liquid Crystal Display) and a CRT (Cathode Ray Tube).

The user may input information from the input apparatus 506. The input may be an instruction for an application or may be a value of data to be updated. The output apparatus 507 may be a display apparatus configured to display an image or may be a device configured to transmit data to the outside (communication interface different from the communication device 504). The display apparatus may display an image of the data in the main storage 502 or the auxiliary storage 503. The external storage medium may be an arbitrary recording medium, such as an HDD, a CD-R, a CD-RW, a DVD-RAM, and a DVD-R.

The main storage 502 is a memory device configured to temporarily store a command executed by the processor 501, various data, and the like. The main storage 502 may be a volatile memory, such as a DRAM, or may be a non-volatile memory, such as an MRAM. The auxiliary storage 503 is a storage configured to persistently store programs, data, and the like, and examples of the auxiliary storage 503 include an HDD and an SSD. The data held by the DBs of the history storage 201 and the like is saved in the main storage 502, the auxiliary storage 503, or an external storage medium.

Note that a printer configured to print various DBs, calculation values, and information of discriminator may be included in addition to the constituent elements. Furthermore, the configuration of the recommendation apparatus illustrated in FIG. 34 may be changed according to the device from which the status of use is collected.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A recommendation apparatus comprising:
a history acquirer configured to acquire an activity history of a user;
a matching information calculator configured to calculate first matching information for the activity history of a pre-condition defined based on an activity of the user, regarding a control rule including the pre-condition and a post-condition indicating content of control performed for a device, the control rule defining to perform the control indicated by the post-condition when the pre-condition is established; and
a recommender configured to generate recommendation information of the control rule for the user according to the first matching information.

2. The recommendation apparatus according to claim 1, wherein
the history acquirer acquires an operation history of the device,
the pre-condition is defined based on the activity history and the operation history, and
the matching information calculator calculates the first matching information for the activity history and the operation history.

3. The recommendation apparatus according to claim 1, wherein
the history acquirer acquires an operation history of the device and calculates second matching information of the content of the control indicated by the post-condition for the operation history, and
the recommender generates the recommendation information according to the first matching information and the second matching information.

4. The recommendation apparatus according to claim 1, wherein
the history acquirer acquires a surrounding environment history of the user or the device,
the pre-condition is defined based on the surrounding environment history, and
the matching information calculator calculates the first matching information based on the surrounding environment history.

5. The recommendation apparatus according to claim 1, further comprising:
an output device configured to output the recommendation information; and
an input device configured to receive whether to apply the control rule.

6. The recommendation apparatus according to claim 1, further comprising
a discriminator generator configured to generate a discriminator associating the first matching information and a value regarding a possibility that the control rule is approved based on information of whether application of the control rule is approved and the first matching information, wherein
the recommender calculates the value regarding the possibility that the control rule is approved based on the discriminator and the first matching information calculated by the matching information calculator and generates the recommendation information according to the calculated value.

7. The recommendation apparatus according to claim 6, further comprising
a determiner configured to determine validity of the discriminator based on whether to apply the control rule, the first matching information, and the value regarding the possibility.

8. The recommendation apparatus according to claim 7, wherein
the discriminator is a regression model, and
the determiner calculates a coefficient of determination R² as the validity of the discriminator.

9. The recommendation apparatus according to claim 3, further comprising:
an output device configured to output the recommendation information;
an input device configured to receive whether to apply the control rule; and
a discriminator generator configured to generate a discriminator associating the first matching information, the second matching information, and a value regarding a possibility that the control rule is approved based on information of whether application of the control rule is approved, the first matching information, and the second matching information, wherein
the recommender calculates the value regarding the possibility that the control rule is approved based on the discriminator and the first and the second matching information calculated by the matching information calculator, and generates the recommendation information according to the calculated value.

10. The recommendation apparatus according to claim 9, further comprising
a determiner configured to determine validity of the discriminator based on whether to apply the control rule, the first matching information, the second matching information, and the value regarding the possibility.

11. The recommendation apparatus according to claim 10, wherein
the discriminator is a regression model, and
the determiner calculates a coefficient of determination R² as the validity of the discriminator.

12. The recommendation apparatus according to claim 1, further comprising
an activity estimator configured to estimate an activity of the user based on at least an operation history of the device, of the activity history and the operation history, wherein
the history acquirer uses the activity estimator to acquire the activity history.

13. The recommendation apparatus according to claim 1, further comprising
a recommendation effect calculator configured to calculate information regarding fluctuation of power consumption of the device when the control rule is applied based on the activity history and an operation history of the device, wherein
the recommender generates the recommendation information based on the information.

14. The recommendation apparatus according to claim 1, wherein
the matching information calculator calculates the first matching information according to a ratio of time or the number of times that the pre-condition becomes true to a reference time or a reference number of times.

15. The recommendation apparatus according to claim 3, wherein
the matching information calculator calculates the second matching information according to a ratio of time or the number of times that the pre-condition becomes true to time or the number of times that the post-condition becomes true in the time that the pre-condition becomes true.

16. The recommendation apparatus according to claim 1, wherein
the recommender determines whether to recommend the control rule based on the first matching information and generates the recommendation information according to a result of the determination.

17. The recommendation apparatus according to claim 1, wherein
the pre-condition includes a condition regarding time of the activity of the user,
the pre-condition includes the activity of the user as a variable,
the control rule is generated by providing the activity of the user to the variable of the pre-condition, and
when the matching information calculator calculates the first matching information, the matching information calculator expands or contracts a range of the time defined by the condition included in the pre-condition according to the activity of the user provided to the variable.

18. The recommendation apparatus according to claim 3, wherein
the pre-condition includes the activity of the user as a variable,
the control rule is generated by providing the activity of the user to the variable of the pre-condition, and
when the matching information calculator calculates the second matching information, the matching information calculator expands a range of the control defined by the post-condition according to the activity of the user provided to the variable.

19. A recommendation method executed by a computer, the recommendation method comprising:
acquiring an activity history of a user;
calculating first matching information for the activity history of a pre-condition defined based on an activity of the user, regarding a control rule including the pre-condition and a post-condition indicating content of control performed for a device, the control rule defining to perform the control indicated by the post-condition when the pre-condition is established; and
generating recommendation information of the control rule for the user according to the first matching information.

20. A non-transitory computer readable medium having a computer program stored therein which causes a computer when executed by the computer, to perform processes comprising:
acquiring an activity history of a user;
calculating first matching information for the activity history of a pre-condition defined based on an activity of the user, regarding a control rule including the pre-condition and a post-condition indicating content of control performed for a device, the control rule defining to perform the control indicated by the post-condition when the pre-condition is established; and
generating recommendation information of the control rule for the user according to the first matching information.
